(19) United States
(12) Patent Application Publication
(10) Pub. No.: US 2011/0260572 A1
(43) Pub. Date: Oct. 27, 2011

(54) MOTOR STATOR AND MANUFACTURING METHOD OF MOTOR STATOR

(75) Inventors: Kazuhito Hiraga, Wako-shi (JP); Kenichi Omagari, Wako-shi (JP); Takumi Shibata, Wako-shi (JP); Masahito Kakema, Wako-shi (JP); Yoshihisa Matsuoka, Wako-shi (JP); Mitsuhiro Okamura, Wako-shi (JP); Eiji Ninomiya, Wako-shi (JP); Takeshi Yanagisawa, Wako-shi (JP)

(73) Assignee: HONDA MOTOR CO., LTD., Tokyo (JP)

(21) Appl. No.: 13/089,583

(22) Filed: Apr. 19, 2011

(30) Foreign Application Priority Data
Apr. 27, 2010 (JP) 2010-102501
Apr. 27, 2010 (JP) 2010-102502
Apr. 27, 2010 (JP) 2010-102503
Apr. 27, 2010 (JP) 2010-102504

(51) Int. Cl. H02K 3/28; H02K 3/34; H02K 15/02

(52) U.S. Cl. 310/207; 29/596; 310/215

(57) ABSTRACT

A motor stator (10) is provided with a stator core (11) having a plurality of slots (16), insulation members (12) which are disposed in the plurality of slots, and coils of a plurality of phases (13) which are respectively formed by distributed-winding wires (20) in prescribed slots of the plurality of slots disposed spaced apart at intervals of a predetermined number of slots via the insulation members. The wires are disposed within the insulation members in a condition that tensions are applied to the wires. The stator core, the insulation members and the coils are physically fixed together by the tensions of the wires.

### BACKGROUND OF THE INVENTION

1. Field of the Invention

The present invention relates to a stator of a motor which is mainly used as a power source for an electric vehicle or a hybrid vehicle and in which wires are distributed-wound, and a manufacturing method thereof.

2. Related Art

Conventionally, stators of distributed-winding motors are manufactured by using a series-winding method in which coils are formed by series-winding wires relative to a stator core or an insert method in which coils which are formed in advance by winding wires are inserted into slots in a stator core.

As the series-winding method, there is disclosed a method and apparatus for winding wires of a stator core. In the method and apparatus, a former detachable installation and replacement portion, a winding arm drive portion, an inspection portion and an interphase insulator installation portion are sequentially disposed around the circumference of a stator core held by a holder, and a wire nozzle is moved in an axial direction and around an axis of the stator core while the stator core is rotated by a predetermined angle for execution of the wires winding work by the single equipment (refer to Patent Document 1, for example). As is shown in FIG. 35, U-, V- and W-phase coils 1112, 1113, 1114 are wound in corresponding slots 1111 in a stator core 1110 by the method and apparatus for winding wires of a stator core.

In addition, as shown in FIG. 36, there is also known a method and apparatus for winding wires of a stator core.

In the method and apparatus, the apparatus includes a nozzle 1121 relatively movable in three-dimensional directions to a stator core 1110 for feeding wires 1115 and guides 1122, 1123 relatively movable in a radial direction to the stator core 1110. Then, the wires 1115 inserted in a slot are wound around by relatively moving these guides 1122, 1123 so as to increase the winding space factors of coils 1112, 1113, 1114 (refer to Patent Document 2, for example).

As the insert method, there is proposed an outer core manufacturing system 1130 which includes, as is shown in FIG. 37, blades 1125 which are inserted into a stator core 1110, a coil insertion jig 1126 for pushing a coil 1112 hooked on the blades 1125 into the stator core 1110, wedge guides 1128 for guiding wedges 1127, a wedge insertion jig 1129 for pushing the wedges 1127 into a slot and a load cell 1131 for measuring a wedge insertion force for detecting abnormality in inserting the wedges 1127 in a stator manufacturing process (refer to Patent Document 3, for example).

In the case of a motor stator manufactured by the method and apparatus of winding wires of a stator core described in Patent Document 1, however, since slots for other phases (for example, V-phase slots and W-phase slots) exit between slots for the same phase (for example, U-phase slots), when wires are attempted to be inserted from a U-phase slot to the following U-phase slot, coil end portions of the wires straddle the slots for the other phases. When the wires are attempted to be inserted rectilinearly into the U-phase slot, the coil end portions cover the slots for the other phases (V-phase slots, W-phase slots). As this occurs, it is not possible to insert many wires in the slots for the other phases, which decreases the winding space factors of the resulting V- and W-phase coils. Because of this, as is shown in FIG. 35, in order for the V-phase coil 1113 to be inserted into a slot 1111 without decreasing the winding space factor thereof, a coil end portion 1112a of a U-phase coil 1112 which has already been inserted needs to be displaced largely towards an outer circumferential side of the stator core 1110 in advance so as to ensure a space for insertion of the V-phase coil 1113. Further, in order for a W-phase coil 1114 to be inserted into a slot 1111, a coil end portion 1113a of the V-phase coil 1113 which has already been inserted also needs to be displaced largely towards the outer circumferential side of the stator core 1110 so as to ensure a space for insertion of the W-phase coil 1114.

As a result of this, the coil end portions 1112a, 1113a, 1114a, which do not directly contribute to the increase in motor performance, become large, which increases the size of the motor. In addition, since the coil volume become large, the weight of the motor is also increased, this increasing, in turn, the coil resistance. As a result of this, the copper loss becomes large, leading to a problem that the motor efficiency is decreased. In addition, in order to fix the coils 1112, 1113, 1114 of the three phases, after the wires 1115 are wound around, a lacing treatment and a varnish treatment need to be applied to the wires 1115.

In addition, according to the method and apparatus for winding wires of a stator core described in Patent Document 2, since the wires 1115 are wound around while the wires 1115 are displaced radially outwards in the slot 1111 by the guides 1122, 1123 so as to be positioned there temporarily, the winding space factors of the coils 1112, 1113, 1114 can be increased to some extent. However, the coils 1112, 1113, 1114 are not fixed to the stator core 1110, and therefore, after the wires 1115 are wound around, a lacing treatment and a varnish treatment need to be applied to the wires 1115, which requires many man hours in manufacturing a stator, leading to a problem that the manufacturing costs are increased.

Additionally, according to the outer core manufacturing system 1130 of Patent Document 3, wires 1115 are formed into a coil 1112 in advance, and this coil 1112 is pushed into a slot in the stator core 1110 by the coil insertion jig 1126 while inclining the coil 1112 obliquely relative to the stator core 1110. Because of this, the wires 1115 become longer than the length which is actually required as a product. As a result of this, the coil volume which is wasteful is increased, and not only are the motor weight and the coil resistance increased, but also the copper loss is increased, leading to a problem that the motor efficiency is decreased. In addition, the increase in size of the motor is also problematic, there exists room for improvement. Further, also with the system of Patent Document 3, it still remains problematic to apply a lacing treatment and a varnish treatment to the coil 112 which has already been pushed into the slot.

In addition, with a single wire having high rigidity, a stator is manufactured by forming in advance a plurality of divided wires into predetermined shapes and joining them together. Additionally, in stators of motors, in order to ensure the insulation between a stator core and wires and between coils of different phases, it is common practice to ensure an insulation distance by inserting an insulation member such as a paper insulator between the stator core and the wires and between wires of different phases (for example, refer to Patent Document 4).

FIGS. 38 (a) and 38(b) show a sectional view of a main part of the stator described in Patent Document 4 and a perspective view showing a manufacturing method thereof. This stator 1 is manufactured by superposing end portions of a sheet-shaped electrical insulation member 2 one on the other so as to be formed into a cylindrical shape, disposing the resulting electrical insulation members 2 in slots 4 formed in a stator core 3, inserting segments 5 which are formed into a U-shape in advance are individually inserted into the cylindrical electrical insulation members 2 and further bending distal end portions of each segment 5 in circumferentially opposite directions to each other so as to be joined to distal end portions of other segments 5.

In the stator 1 described in Patent Document 4, however, since the electrical insulation members 2, the stator core 3 and the wires (segments) 5 are fixed in place by means of frictional forces thereof only, the fixing forces are not necessarily sufficient. Because of this, after having been wound, the wirings need a racing treatment or a varnish treatment, leading to a problem that many labors have to be involved in manufacturing of the stator, which increases the manufacturing costs. In addition, since the electric insulation member 2 is the sheet-like member, the wires are wound slowly without large force being exerted thereon so as not to generate any failure or breakdown in insulation. As a result of this, the lengths of the wires are longer than needed, leading to a problem that the motor efficiency is badly affected.
[Patent Document 1] JP-A-2007-006677
[Patent Document 2] US2003/0168547
[Patent Document 3] JP-A-2006-166675
[Patent Document 4] U.S. Pat. No. 6,242,836

### SUMMARY OF THE INVENTION

One or more embodiments of the invention provide a motor stator which can decrease the coil volume so as to suppress the coil resistance and copper loss to thereby increase the motor efficiency, which can realize a reduction in weight and size of a motor and which can eliminate or simplify a coil fixing treatment such as a lacing treatment and a varnish treatment.

According to embodiments of the invention, a motor stator 10, 110 may include a stator core 11, 111 having a plurality of slots 16, 116, insulation members 12, 112 which are disposed in the plurality of slots, and coils of a plurality of phases 13u, 13v, 13w, 113u, 113v, 113w which are respectively formed by distributed-winding wires 20, 20A, 120 in prescribed slots of said plurality of slots disposed spaced apart at intervals of a predetermined number of slots via the insulation members. The wires may be disposed within the insulation members in a condition that tensions are applied to the wires. The stator core, the insulation members and the coils may be physically fixed together by the tensions of the wires.

Moreover, according to embodiments of the invention, a manufacturing method of a motor stator 10, 110 in which coils of a plurality of phases 13u, 13v, 13w, 113u, 113v, 113w are formed by distributed-winding wires 20, 20A, 120 in a plurality of slots 16, 116 which are provided on a stator core 11, 111 and disposed spaced apart with a predetermined number of slots interposed therebetween, may include the steps of: disposing insulation members 12, 112 in the plurality of slots for establishing electrical insulation between the stator core and the wires; distributed-winding the wires in the plurality of slots; and disposing the wires within the insulation members in a condition that tensions are applied to the wires, and physically fixing the stator core, the insulation members and the coils together.

Other aspects and advantages of the invention will be apparent from the following description and the appended claims.

### BRIEF DESCRIPTION OF THE DRAWINGS

FIG. 1 is an enlarged perspective view of a main part of a motor stator according to a first embodiment showing a state in which wires are distributed-wound around the motor stator.

FIG. 2 is an exemplary diagram showing a wound state of wires shown in FIG. 1.

FIG. 3 is a partial enlarged view of the stator as viewed from an inside diameter side.

FIG. 4 is an enlarged perspective view of a main part of the motor stator showing a wound state of wires for one phase.

FIG. 5 is a sectional view showing a state of wires inserted into a slot.

FIGS. 6(a) and 6(b) are drawings which explains space factor.

FIG. 7(a) is a manufacturing flowchart showing a manufacturing process of the motor stator according to the first embodiment, and FIG. 7(b) is a manufacturing flowchart showing a conventional manufacturing process.

FIG. 8 is an enlarged view of a main part of a manufacturing apparatus of the motor stator.

FIG. 9 is a conceptual plan view of the manufacturing apparatus shown in FIG. 8.

FIGS. 10(a) to 10(f) are enlarged views of a main part of a winding procedure which show step by step a procedure of winding wires around a stator core by the manufacturing apparatus shown in FIG. 8.

FIG. 11 is a side view showing a state in which a tension is applied to a wire by hooks of the manufacturing apparatus.

FIG. 12 is an enlarged perspective view of a main part of a motor stator according to a second embodiment.

FIG. 13 is an exemplary diagram showing a wound state of wires of the motor stator of the second embodiment.

FIG. 14 is a partial enlarged view of the stator as viewed from an inside diameter side.

FIG. 15 is an enlarged perspective view of a main part of the motor stator showing a wound state of wires for one phase.

FIG. 16 is a sectional view showing a state of wires inserted into a slot.

FIGS. 17(a) and 17(b) are drawings which explains space factor.

FIGS. 18(a) and 18(b) are sectional views showing states of wires having different sectional areas which are inserted into a slot.

FIG. 19 is a graph showing a relationship between wire diameter and insulating surface coating ratio when insulating surface coating thicknesses are the same.

FIG. 20 is a graph showing a relationship between insulating surface coating thickness and PDIV (Partial Discharge Initiating Voltage) based on a Dakin expression.

FIG. 21 is a sectional view of a single wire coated with an insulating surface coating.

FIG. 22 is a sectional view of a single wire coated with a composite insulating surface coating formed of inorganic particles dispersed in a resin.

FIG. 23(a) is a manufacturing flowchart showing a manufacturing process of the motor stator according to the second embodiment, and FIG. 23(b) is a manufacturing flowchart showing a conventional manufacturing process.

FIG. 24 is an enlarged view of a main part of a manufacturing apparatus of the motor stator.

FIG. 25 is a conceptual plan view of the manufacturing apparatus shown in FIG. 23.

FIGS. 26(a) to 26(f) are perspective views of a main part of a winding procedure which show step by step a procedure of winding wires around a stator core by the manufacturing apparatus shown in FIG. 24.

FIG. 27 is a side view showing a state in which a tension is applied to a wire by hooks of the manufacturing apparatus.

FIG. 28 is an exemplary diagram showing a wound state of wires of a motor stator of a third embodiment.

FIG. 29 is a manufacturing flowchart showing a manufacturing method of the motor stator according to the third embodiment.

FIG. 30 is a perspective view showing wires made of divided single wires.

FIG. 31 is an exemplary diagram showing a state in which the wires of the divided single wires are inserted into slots.

FIG. 32 is an exemplary diagram showing a state in which the wires in FIG. 31 are bent.

FIG. 33 is a partial enlarged view of the stator as viewed from an inside diameter side which depicts an axial fixing when bending the wire.

FIG. 34 is a sectional view showing a state in which a plurality of single wires having different sectional shapes are inserted into a slot with minimum gaps.

FIG. 35 is an enlarged view of a main part of a conventional motor stator.

FIG. 36 is an enlarged perspective view of a main part of another conventional motor stator showing a state in which wires are series wound on the motor stator.

FIG. 37 is a conceptual diagram of a further conventional manufacturing system for inserting a coil formed of wires into a slot in a stator core.

FIG. 38(a) is a sectional view of a main part of a conventional stator, and FIG. 38(b) is a perspective view of a main part of a manufacturing procedure of the stator.

### DETAILED DESCRIPTION OF EMBODIMENTS

Hereinafter, embodiments of the invention will be described based on the accompanying drawings. Note that the drawings are to be viewed in accordance with an orientation of reference numerals.

### First Embodiment

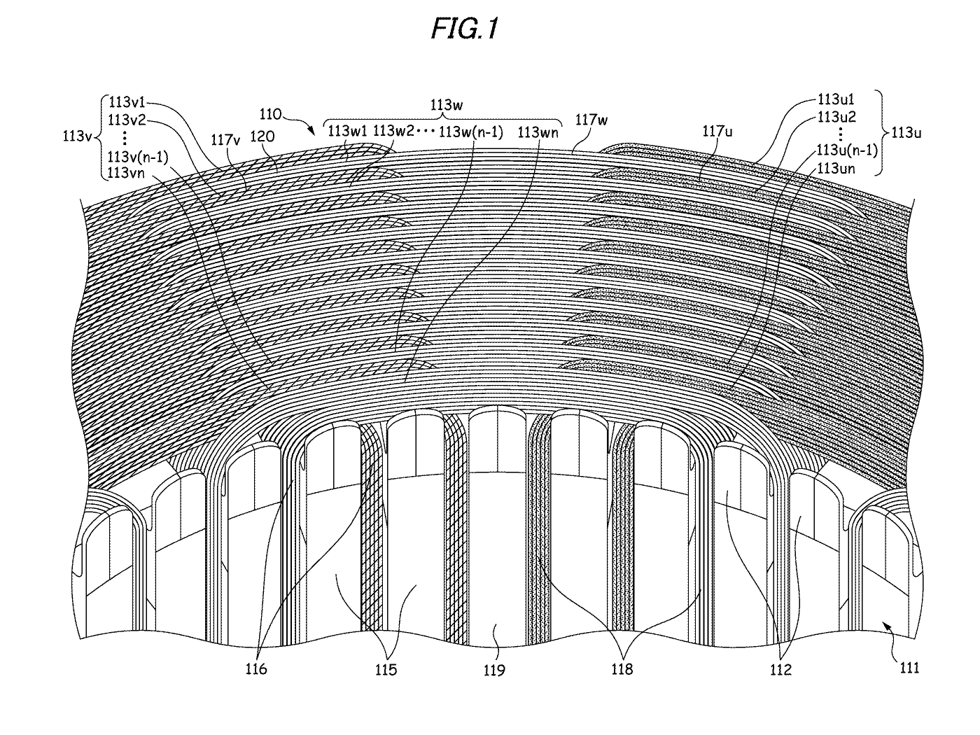

As is shown in FIG. 1, a motor stator 110 according to a first embodiment is a three-phase, eight-pole, distributed-winding stator and includes a stator core 111, insulation members 112, and coils 113 (a U-phase coil 113u, a V-phase coil 113v, and a W-phase coil 113w). The stator core 111 is made up of, for example, a plurality of pressed silicon steel sheets which are stacked one on another and includes 148 tees 115 and 148 slots 116 which are each formed between adjacent tees 115, 115. In addition, a motor is an inner rotor type motor, and an opening portion 118 of the slot 116 is opened in an inner circumferential surface 119 of the stator core 111.

A plurality of insulation members 112 are inserted into each slot 116 from both axial ends of the stator core 111 so as to cover an inner surface of the slot 116. Each insulation member 112 is formed of resin material through injection molding and has electric insulation properties and appropriate elasticity. The insulation members 112 are intended to establish electric insulation between the coils 113u, 113v, 113w of the respective phases. As resin materials for use in injection molding, there are raised polyamide, polyethylene terephthalate, polybutylene terephthalate, polyether ether ketone, polyphenylene sulfide, for example.

The insulation member 112 is not limited to such a resin molded product, provided that the insulation member 112 does not damage a wiring 120 when the wiring 120 is wound while a tension is applied thereto and can ensure an insulation performance. Thus, for example, an aramid paper having an appropriate thickness and elasticity can also be used. In addition, relevant portions of the stator core 111 may be coated with resin for use as insulation members 112. Further, when a voltage applied to the coils 113 is high (for example, 650V or higher), interphase paper insulators may be disposed between the coils of the three phases in accordance with voltages applied.

A U-phase coil 113w, V-phase coil 113v and W-phase coil 113 are formed by inserting wires 120, each of which is made by binding up a plurality of (11 strands in this embodiment) strands 120′ such as thin polyamide imide copper wires (refer to FIG. 5), in predetermined slots 116 to be wound around the stator core 111 through wave-winding.

Respective coil end portions 117u, 117v, 117w of the U-, V- and W-phase coils 113u, 113v, 113w are disposed alternately in a radial direction of the stator core 111 in accordance with the sequence of turns so that end portions (117u and 117v, 117v and 117w or 117w and 117u) of the coils of the two phases in the three phases (113u and 113v, 113v and 113w or 113w and 113u) are aligned in the radial direction.

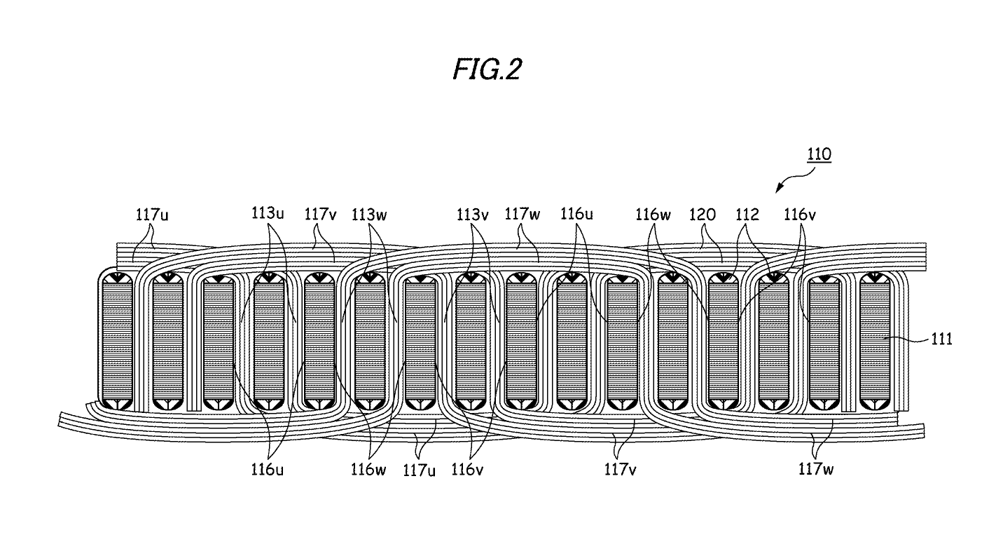

As is shown in FIGS. 2 to 4, the stator 110 of this embodiment is a double-slot type stator in which for each phase two sets of wires 120 are distributed-wound around adjacent slots 116 (U-phase slots 116u, V-phase slots 116v, W-phase slots 116w) in the stator core 111 through wave-winding. Slots 116 are disposed in a circumferential direction of the stator core 111 in the order of U-phase slot 116u, V-phase slot 116v and W-phase slot 116w in a repeated fashion.

Specifically, at first two sets of wires 120, which make up a U-phase coil 113u, are individually inserted into two U-phase slots 116u via the insulation members 112 from an axial end side (a lower end in FIG. 2) towards the other axial end side (an upper end in FIG. 2) of the stator 110 and are then individually inserted into another two U-phase slots 116u which are situated apart from the first two U-phase slots 116u with two adjacent V-phase slots 116v and two adjacent W-phase slots 116w interposed therebetween from the other axial end side towards the axial end side of the stator 110 via the insulation members 112. Thereafter, wires 120 are individually inserted into U-phase slots 116u in a similar fashion through wave-winding so as to extend a full circumference of the stator core 111 to thereby form a first turn 113u1 of the U-phase coil 113u.

Following this, two sets of wires 120, which make up a V-phase coil 113v, are individually inserted into the two V-phase slots 116v which are situated between the two pairs of adjacent U-phase slots 116u via the insulation members 112 from the other axial end side towards the axial end side of the stator 110 and are then individually inserted into another two V-phase slots 116v which are situated apart from the first two V-phase slots 116v with two adjacent W-phase slots 116w and two adjacent U-phase slots 116u interposed therebetween from the axial end side towards the other axial end side of the stator 110 via the insulation members 112. Thereafter, wires 120 are individually inserted into V-phase slots 116v in a similar fashion through wave-winding so as to extend the full circumference of the stator core 111 to thereby form a first turn 113v1 of the V-phase coil 113v.

Similarly, two sets of wires 120, which make up a W-phase coil 113w, are individually inserted into the two W-phase slots 116w which are situated between the two pairs of adjacent U-phase slots 116u via the insulation members 112 from the axial end side towards the other axial end side of the stator 110 and are then individually inserted into another two W-phase slots 116w which are situated apart from the first two adjacent W-phase slots 116w with two adjacent U-phase slots 116u and two adjacent V-phase slots 116v interposed therebetween from the other axial end side towards the axial end side of the stator 110 via the insulation members 112. By winding the wires 120 in this way, a coil end portion 117v of the V-phase coil 113w passes the other axial end side or the axial end side which is opposite to the axial end side or the other axial end side where coil end portions 117u, 117w of the U-phase coil 113u and W-phase coil 113w intersect. Thereafter, wires 120 are individually inserted into W-phase slots 116w in a similar fashion through wave-winding so as to extend the full circumference of the stator core 11 to thereby form a first turn 113w1 of the W-phase coil 113w.

Similarly, a second turn 113u2 of the U-phase coil 113u, a second turn 113v2 of the V-phase coil 113v, a second turn 113w2 of the W-phase coil 113W, a third turn 113u3 of the U-phase coil 113u, . . . are wound around the stator core 111 in that order.

In this way, by disposing the U-phase coil 113u, the V-phase coil 113v and the W-phase coil 113w alternately every turn, the wirings 120 are wave wound around the slots 116, while in the U-phase coil 113u, the V-phase coil 113v and the W-phase coil 113w, the coil end portions (117u and 117w, 117v and 117w or 117w) of the coils of the two phases (113u and 113w, 113v and 113w) are disposed so as to be aligned in the radial direction as is shown in FIG. 1. By disposing the U-phase coil 113u, the V-phase coil 113v and the W-phase coil 113w alternately every turn in the order of turns of the coils of the respective phases, compared with the conventional coils, the volumes of the coil end portions 117u, 117v, 117w become small, whereby the coil volume is reduced.

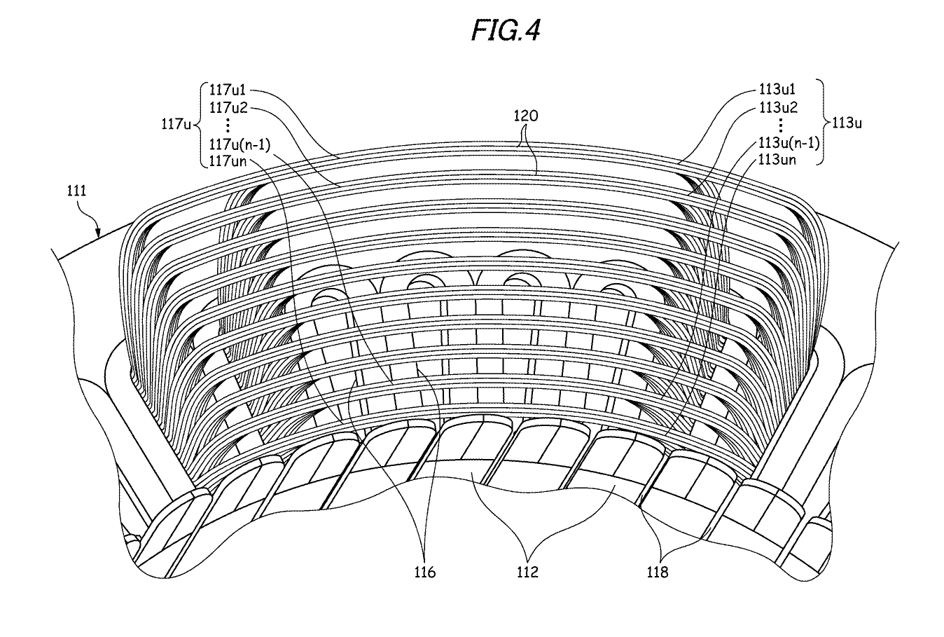

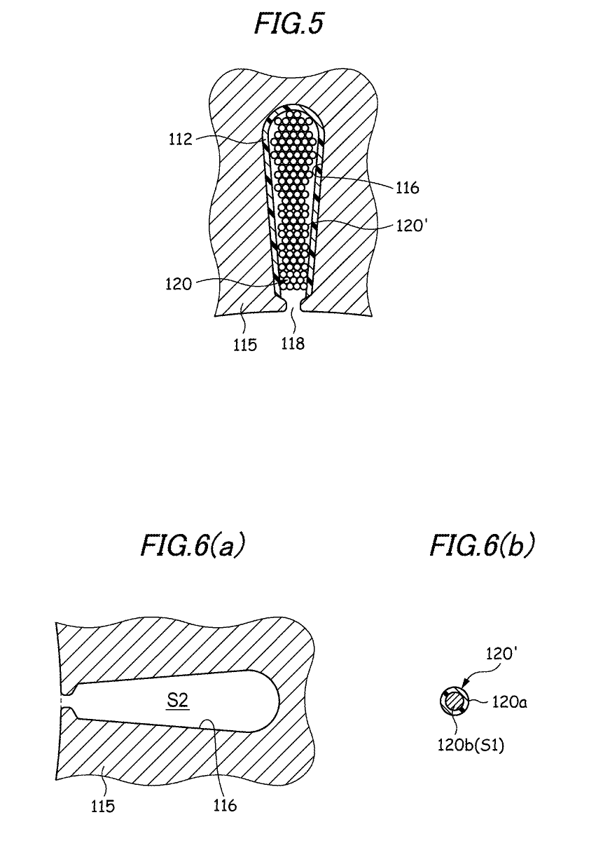

To facilitate the understanding this, FIG. 4 shows only the U-phase coil 113u. The respective coil end portions 117u, 117v, 117w of the three phases are arranged so that the first turn 113w1 of the W-phase coil 113w and the first turn 113v1 of the V-phase coil 113v are inserted in a radial gap defined between the first turn 113u1 and the second turn 113u.

Because of this, the coil end portions 117u are formed so as to be displaced slightly radially outwards every turn to thereby ensure radial gaps. The displacement amount becomes gradually smaller as the coil end portions 117u are displaced from an inside diameter side towards an outside diameter side of the stator core 111. In addition, the displacement amount of the coil end portions 117u may be such that the coil end portions 117u which are disposed from a substantially central portion of a radial thickness of the stator core 111 to the outside diameter side thereof are displaced radially outwards, while the coil end portions 117u which are disposed from the substantially central portion to the inside diameter side are disposed radially inwards. This becomes true with respect to the V-phase coil end portions 117v and the W-phase coil end portions 117w.

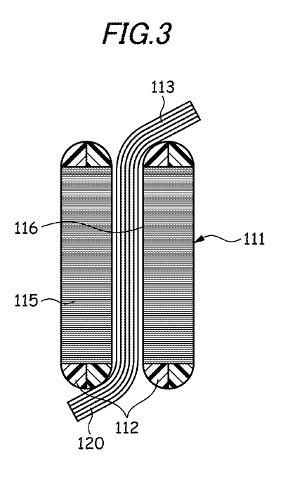

As is shown in FIG. 3, the wires 120 which make up the coils 113u, 113v, 113w of the three phases are bent along the shape of the insulation member 112 and are wave wound around the slots 116u, 116v, 116w of the three phases in the way described above. By the wires 120 being so wound, the stator core 11, the insulation members 112 and the coils 113u, 113v, 113w of the three phases are fixed physically to each other by means of tensions of the wires. Consequently, the necessity of the coil fixing treatment such as the lacing treatment and the varnish treatment, which are implemented with respect to the conventional stator, can be avoided or simplified.

The tension of the wire 120 is preferably equal to or smaller than an allowable elastic stress of the wire 120. Alternatively, a stress exerted on the insulation member 112 by means of the tension of the wire 120 is preferably equal to or smaller than an allowable compression strength thereof. More preferably, both the requirements are met at the same time. The settings ensure that no defect resulting from the tension of the wire 120 is generated such as the plastic deformation or failure of the wound wire 120 and the plastic deformation of the insulation member 112.

As is shown in FIG. 5, wires 120 are disposed in each slot 116 via the insulation members 112, and the V-, U- and W-phase coil end portions 117u, 117v, 117w are disposed alternately in the radial directions in accordance with the order of turns thereof. Thus, there is caused no such situation that the coil of one of the three phases that has already been wound around interrupts the coils of the other phases when they are attempted to be wound around. Thus, the wires 120 can be wound with an increased space factor S of the coils 113. The space factor S of the stator 110 of this embodiment can be 40% or larger. Here, the “space factor S” is defined as a ratio of what results by multiplying a sectional area S1 of an electric conductor portion 120b which results by removing insulating surface coatings 120a from the wires 120 by the number of portions of strands 120′ which pass through the slot 116 and a sectional area S2 of the slot 116.

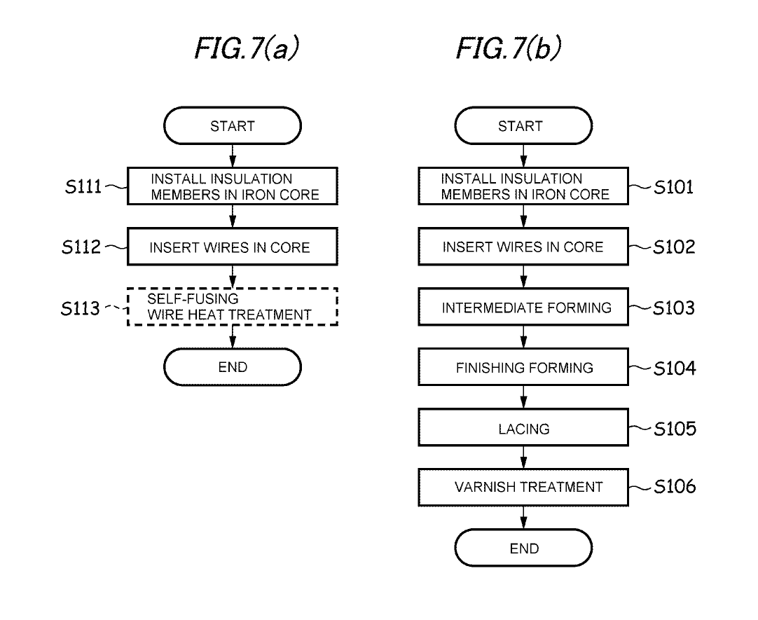

Next, based on FIGS. 7 to 11, a manufacturing method of the motor stator 110 will be described. FIG. 7(a) shows a flowchart of a manufacturing process of a motor stator according to the embodiment, and FIG. 7(b) is a flowchart of a conventional manufacturing process. As is shown in FIG. 7(b), according to the conventional manufacturing method, after insulation members are installed in slots in a stator core (step S101), wires are wound around the stator core (step S102). Then, an intermediate forming is carried out in which coil end portions projecting axially outwards from the stator core are bent radially outwards (step S103), and following this, and a final or finishing forming is carried out in which the coil end portions are shaped properly (step S104). Then, a lacing treatment is carried out of fastening the coils with a lacing string (step S105), and then, a varnish treatment is carried out of impregnating the coils with a varnish and setting the varnish in the coils so as to fix together the stator core, the insulation members and the coils (step S106). In this way, according to the conventional manufacturing method, the motor stator is manufactured through the process of the six steps.

In contract with this, according to the motor stator manufacturing method according to the embodiment, as is shown in FIG. 7(a), the manufacturing process can be reduced to two steps: a step (step S111) of installing insulation members 112 in slots in a stator core (an iron core) 111 and a step (step S112) of winding wires 120 around the stator core 111 via the insulation members 112, whereby not only a reduction in material used but also a remarkable reduction in manufacturing time can be realized to thereby suppress the manufacturing costs. In addition, in the case of a self-fusing wire being used as a wire 120, the fixing of the resulting coils can be simplified by fixing the wires 120 in a simplified fashion by implementing a heat treatment step (step S113).

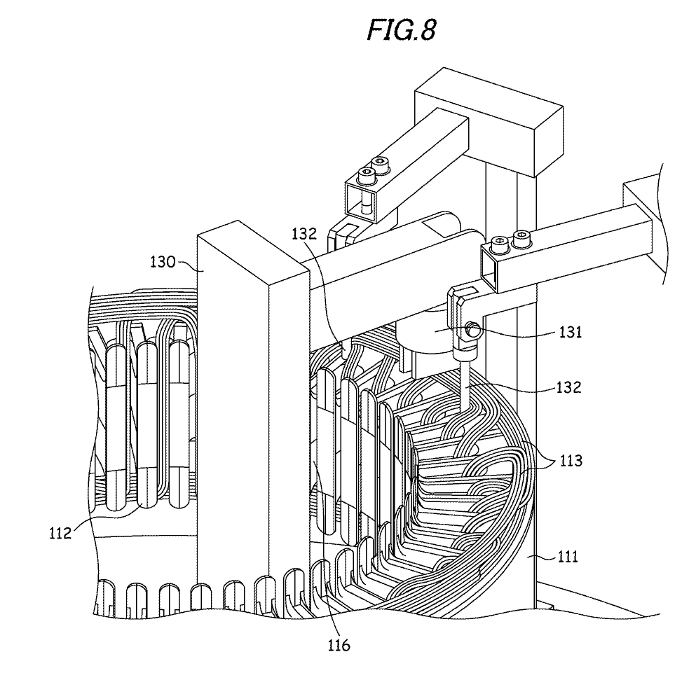

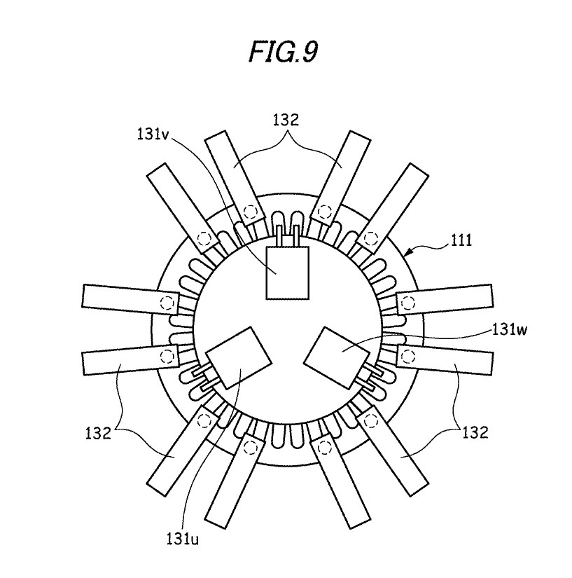

As is shown in FIGS. 8 and 9, wires 120 are wave wound around the stator core 111 by three U-, V- and W-phase nozzles 131 which each discharge two sets of wires 120 to the horizontally disposed stator core 111 and a plurality of hooks 132 which hold the wires 120 so discharged at predetermined positions.

Three nozzles 131 are provided which include a U-phase nozzle 131u which discharge two sets of wires 120 which make up a U-phase coil 113u, a V-phase nozzle 131v which discharges two sets of wires 120 which make up a V-phase coil 113v and a W-phase nozzle 131w which discharges two sets of wires 120 which make up a W-phase coil 113w and which are disposed on an inside diameter side of the stator 111. The nozzles 131u, 131v, 131w can each be moved in a vertical direction and a radial direction of the stator core 111 while discharging two sets of wires 120 by being guided by a corresponding nozzle guide rail 130.

There are disposed 24 hooks 132 in total; 12 hooks 132 are disposed at each of both the axial end sides of the stator core 111. The hooks 132 lock wires 120 which are discharged from the nozzles 131u, 131v, 131w of the three phases in predetermined positions and hold the wires 120 radially outwards of the stator core 111.

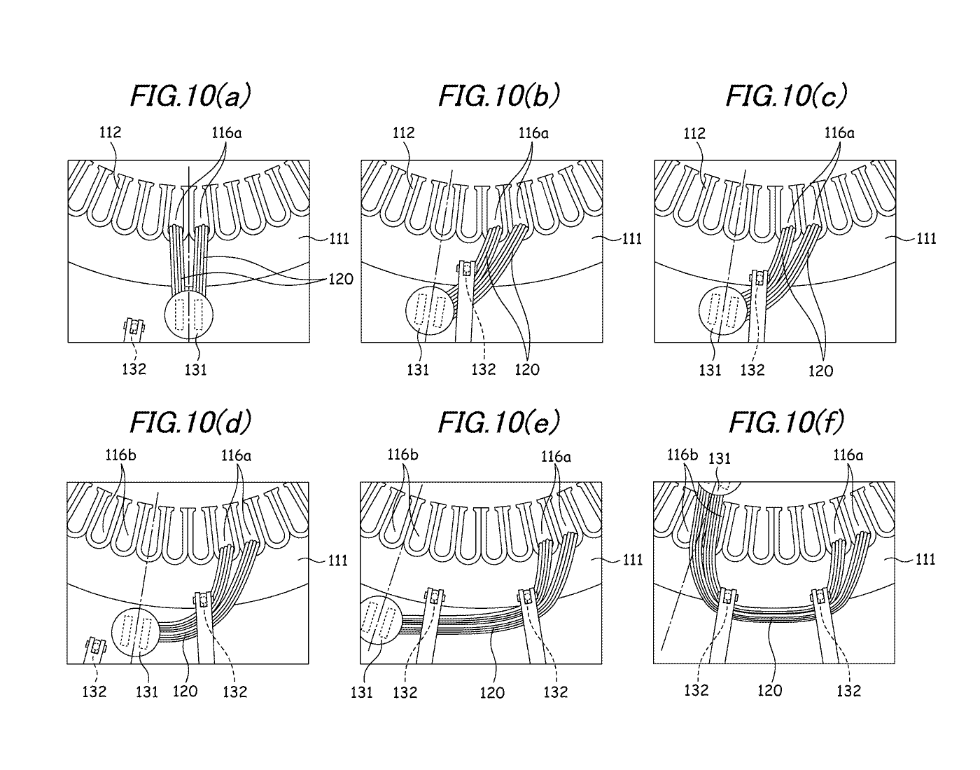

In a specific step of distributed-winding (wave-winding) wires 120 around the stator core 111, as is shown in FIG. 10(a), two sets of wires 120 are individually inserted into a pair of first slots 116a via the insulation members 112 from the axial end side (from a lower end in the figure) towards the other axial end side (an upper end in the figure) of the stator core 111. Then, the wires 120 which are pulled out from the first slots 116a are locked by the hook 132 which is moved radially inwards (FIG. 10(b)) and holds the wires 120 radially outwards of the first slots 116a with a tension applied to the wires 120 (FIG. 10(c)) by displacing the hook 132 radially outwards.

In applying a tension to the wires 120, when the wires 120 are locked by the hook 132 and are then pulled radially outwards, the wires 120 which are inserted in the slots 116 are unbent radially inwards, leading to a fear that the space factor is reduced. In this case, a wire pressing mechanism may be provided so that the wires 120 are wound around while the wires 120 which are unbent in the corresponding slots 116 are pressed radially inwards to correct the unbending thereof.

Next, with the wires 120 kept locked by the hook 132, the stator core 111 is rotated by a predetermined angle together with the hook 132 so that the wires 120 are located at a second pair of second slots 116b into which the wires 120 are to be inserted next. By so rotating the stator 111, the wires 120 which are discharged from the nozzle 131 are disposed along an outer circumference side of the stator core 111 (FIG. 10(d)). Here, with the wires 120 held radially outwards of the second slots 116b by the other adjacent hook 132 (FIG. 10(e)), the wires 120 are inserted into the second slots 116b via the insulation members 112 from the other axial end side (the upper end) towards the axial end side (the lower end) of the stator core 111 (FIG. 10(f)).

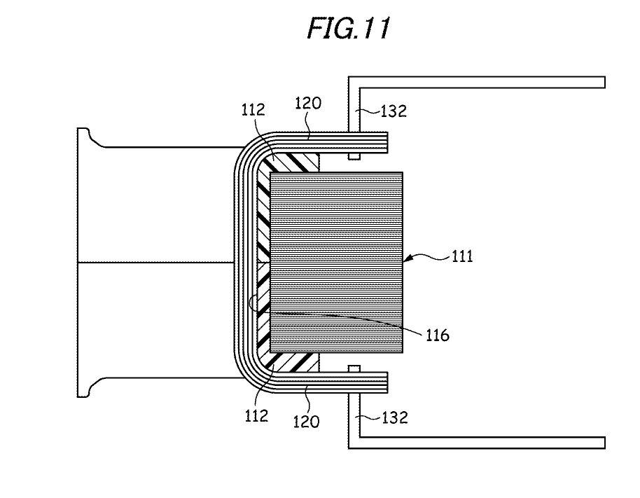

Thereafter, similarly, as is shown in FIG. 11, the wires 120 which are pulled out of the second slots 116b are locked by the hook 132 and are held radially outwards of the second slots 116b while a tension is applied to the wires 120. Then, the stator core 111 is rotated by the predetermined angle together with the hook 132 so that the wires 120 are moved to be located at a pair of third slots. By doing so, the wires 120 which are discharged from the nozzle 131 and are disposed along the outer circumferential side of the stator core 111 are held radially outwards of the third slots. By repeating the steps described above, the coil 113 of one of the three phases (for example, the U-phase coil 113u) is wave wound around the stator core 111.

The series of operations are performed simultaneously by the three nozzles 131 of the U-phase nozzle 131u, the V-phase nozzle 113v and the W-phase nozzle 113w, whereby the three coils 113 of the U-phase coil 113u, the V-phase coil 113v and the W-phase coil 113w are formed while being disposed alternately in accordance with the order of turns.

Thus, as has been described heretofore, according to the motor stator 110 of the embodiment, the wires 120 which are each made up of the plurality of strands are distributed-wound in the insulation members 112 within the slots 116 while being tensioned, whereby the coils of the plurality of phases 113u, 113v and 113w are formed individually. By winding the wires 120 in that way, the stator core 111, the insulation members 112 and the coils 113 are physically fixed together by means of a tension applied to the wires 120. Therefore, the lacing operation and the vanishing operation can be avoided or simplified, which can simplify the manufacturing process, whereby the manufacturing costs of the motor stator 110 can be suppressed. Here, that the stator core 111, the insulation members 112 and the coils 113 are fixed together physically means a state in which there is caused almost no change in the relative positional relationship between the stator core 111, the insulation members 112 and the coils 113 by means of the tension applied to the wires 120.

Additionally, the coil end portions 117u, 117v, 117w of the coils 113u, 113v, 113w of the three phases are disposed alternately on the stator core 111 in accordance with the order of turns thereof. Therefore, the coil volume is reduced, which suppresses the coil resistance and copper loss, thereby making it possible to increase the motor efficiency. In addition, a reduction in weight and size of the motor can be realized.

Furthermore, the insulation member 112 is the elastic resin member. Therefore, in forming the coils of the plurality of phases 113u, 113v, 113w, even in the event that the wires 120 are distributed-wound in the insulation members 112 while being tensioned, there is no fear that the wires 120 are damaged, whereby the predetermined motor performance is maintained.

In addition, the tension applied to the wire 120 is equal to or smaller than the allowable elastic stress of the wire 120 and/or equal to or smaller than the allowable compression strength of the insulation member 112. Therefore, in forming the coils of the plurality of phases 113u, 113v and 113w, even in the event that the wires 120 are distributed-wound around the insulation members 112 while being tensioned, there is caused no such situation that the wires 120 and the insulation members 112 are plastically deformed, whereby the predetermined motor performance is maintained.

Further, the opening portions 118 of the slots 116 are opened in the inner circumferential surface 119 of the stator core 111. Therefore, the motor stator 110 of this embodiment can preferably be used as a motor stator for an inner rotor type motor.

Additionally, the space factor S of the coils 113 disposed in the slots 116 is 40% or smaller. Therefore, an increase in motor efficiency can be realized.

In addition, the coils 113 of the three phases of U-phase, V-phase and W-phase are formed by wave-winding the wires 120 in the plurality of slots 116 so that the coil end portions 117 of the coils 113 of the two phases are aligned in the radial direction. Therefore, the coil volume can be reduced, thereby making it possible to increase the motor efficiency by suppressing the coil resistance and copper loss. In addition, a reduction in weight and size of the motor can be realized.

Further, the wires 120 are inserted into the first slot 116a from the axial end side towards the other axial end side of the stator core. Then, the wires 120 which are pulled out of the first slot 16a are held while being tensioned in the position lying radially outwards of the first slot. Thereafter, the stator core 111 is rotated to be located at the second slot 116b into which the wires 120 are to be inserted next, and the wires 120 are held in the position lying radially outwards of the second slot 116b. Following this, the wires 120 are inserted into the second slot 116b in the opposite direction to the direction in which the wires 120 are inserted in the previous insertion thereof and are held while being tensioned in the position lying radially outwards of the second slot 116b. Thereafter, the stator core 111 is rotated to be located at the third slot 116 into which the wires 120 are to be inserted next and are held in the position lying radially outwards of the third slot. Since this series of steps is made to be repeated, the wires 120 can be wave wound in the plurality of slots 116 while being tensioned so that the coil end portions 117 of the coils 113 of the two phases are aligned in the radial direction. By this configuration, not only can the lacing treatment and the varnish treatment be avoided or simplified so as to simplify the manufacturing process, but also the coil resistance and copper loss can be suppressed so as to increase the motor efficiency. In addition, a reduction in weight and size of the motor can be realized.

### Example

Table 1 shows a comparison made between the motor stator according to the embodiment which is manufactured by the method shown in FIG. 7(a) and the motor stator which is manufactured by the conventional method shown in FIG. 7(b). Note that in Table 1, values given to the motor stator of the embodiment with respect to respective items indicate ratios to values given to the conventional motor stator when the latter values are regarded as 100.

TABLE 1

| | Conventional | Stator of the | |
|---|---|---|---|
| | Stator | Embodiment | Advantage |
| Wire Weight | 100 | 87 | Weight |
| | | | Reduction |
| Copper Loss | 100 | 94 | Efficiency |
| | | | Increase |
| Coil End | 100 | 85 | Size Reduction |
| Portion | | | |
| Sectional Area | | | |

As is shown in Table 1, compared with the conventional motor stator, in the motor stator according to the embodiment, the wire weight and the copper loss are reduced to 87% and 94%, respectively. By these reductions, not only is the overall weight of the motor reduced, but also the motor efficiency is increased. In addition, the sectional area of the coil end portion is reduced to 85% and hence, the eight of the coil end portion is lowered. Therefore, the size of the motor is reduced, and the resulting space factor is 45%. Further, since the wires are disposed within the resin insulation members while being tensioned, the coils are fixed sufficiently without applying the lacing treatment and the varnish treatment thereto.

### Second Embodiment

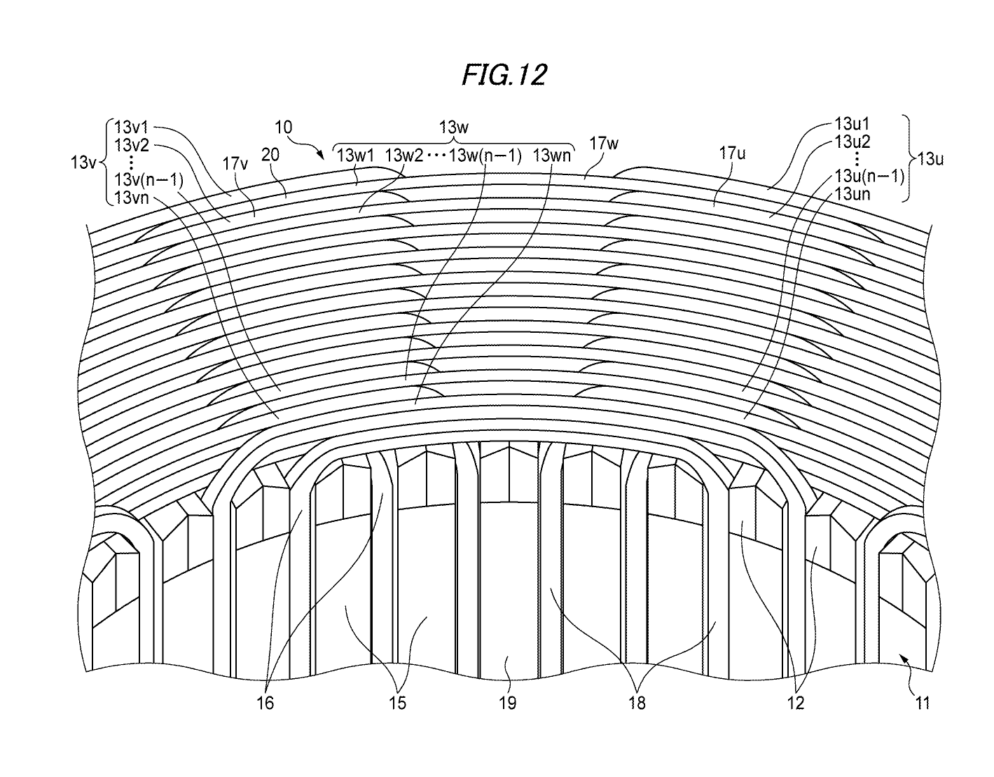

As is shown in FIG. 12, a motor stator 10 according to a second embodiment of the invention is a three-phase, eight-pole, distributed-winding stator and includes a stator core 11, insulation members 12, and coils 13 (a U-phase coil 13u, a V-phase coil 13v, and a W-phase coil 13w). The stator core 11 is made up of, for example, a plurality of pressed silicon steel sheets which are stacked one on another and includes 48 tees 15 and 48 slots 16 which are each formed between adjacent tees 15, 15. An opening portion 18 of the slot 16 is opened in an inner circumferential surface 19 of the stator core 11.

A plurality of insulation members 12 are inserted into each slot 16 from both axial ends of the stator core 11 so as to cover an inner surface of the slot 16. Each insulation member 12 is formed of resin material through injection molding and has electric insulation properties and appropriate elasticity. The insulation members 12 are intended to establish electric insulation between the coils 13u, 13v, 13w of the respective phases. As resin materials for use in injection molding, there are raised polyamide, polyethylene terephthalate, polybutylene terephthalate, polyether ether ketone, polyphenylene sulfide, for example.

The insulation member 12 is not limited to such a resin molded product, provided that the insulation member 12 does not damage a wiring 20 when the wiring 20 is wound while a tension is applied thereto and can ensure an insulation performance. Thus, for example, an aramid paper having an appropriate thickness and elasticity can also be used. In addition, relevant portions of the stator core 11 may be coated with resin for use as insulation members 12.

A U-phase coil 13w, V-phase coil 13v and W-phase coil 13 are formed by inserting wires 20, each of which is made of a single conductive wire, in predetermined slots 16 to be wound around the stator core 11 through wave-winding.

Respective coil end portions 17u, 17v, 17w of the U-, V- and W-phase coils 13u, 13v, 13w are disposed alternately in a radial direction of the stator core 11 in accordance with the sequence of turns so that end portions (17u and 17v, 17v and 17w or 17w and 17u) of the coils of the two phases in the three phases (13u and 13v, 13v and 13w or 13w and 13u) are aligned in the radial direction.

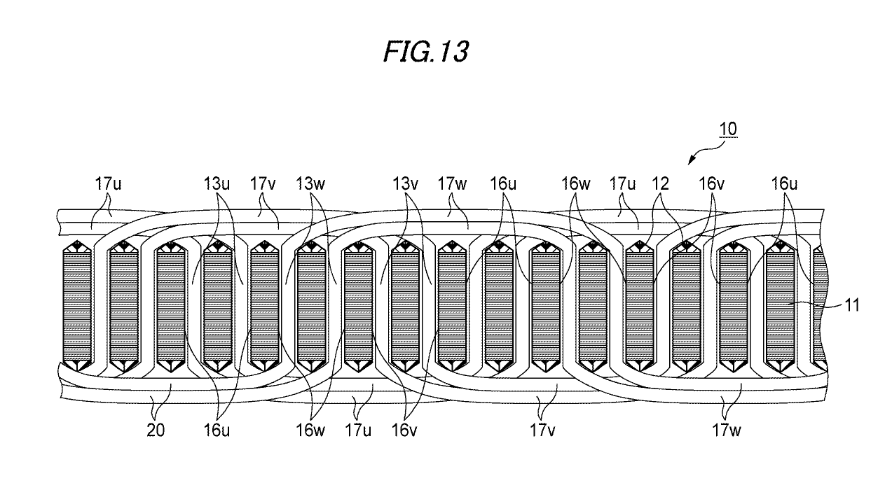

As is shown in FIGS. 13 to 15, the stator 10 of this embodiment is a double-slot type stator in which for each phase two wires 20 are distributed-wound around adjacent two slots 16 (U-phase slots 16u, V-phase slots 16v, W-phase slots 16w) in the stator core 11 through wave-winding. Slots 16 are disposed in a circumferential direction of the stator core 11 (from a right-hand side to a left-hand side in FIG. 13) in the order of U-phase slot 16u, V-phase slot 16v and W-phase slot 16w in a repeated fashion.

Specifically, at first two wires 20, which make up a U-phase coil 13u, are individually inserted into two adjacent U-phase slots 16u via the insulation members 12 from an axial end side (a lower end in FIG. 13) towards the other axial end side (an upper end in FIG. 13) of the stator 10 and are then individually inserted into another two adjacent U-phase slots 16u which are situated apart from the first two adjacent U-phase slots 16u with two adjacent V-phase slots 16v and two adjacent W-phase slots 16w interposed therebetween from the other axial end side towards the axial end side of the stator 10 via the insulation members 12. Thereafter, wires 20 are individually inserted into U-phase slots 16u in a similar fashion through wave-winding so as to extend a full circumference of the stator core 11 to thereby form a first turn 13u1 of the U-phase coil 13u.

Following this, two wires 20, which make up a V-phase coil 13v, are individually inserted into the two adjacent V-phase slots 16v which are situated between the two pairs of adjacent U-phase slots 16u via the insulation members 12 from the other axial end side towards the axial end side of the stator 10 and are then individually inserted into another two adjacent V-phase slots 16v which are situated apart from the first two adjacent V-phase slots 16v with two adjacent W-phase slots 16w and two adjacent U-phase slots 16u interposed therebetween from the axial end side towards the other axial end side of the stator 10 via the insulation members 12. Thereafter, wires 20 are individually inserted into V-phase slots 16v in a similar fashion through wave-winding so as to extend the full circumference of the stator core 11 to thereby form a first turn 13v1 of the V-phase coil 13v.

Similarly, two wires 20, which make up a W-phase coil 13w, are individually inserted into the two adjacent W-phase slots 16w which are situated between the two pairs of adjacent U-phase slots 16u via the insulation members 12 from the axial end side towards the other axial end side of the stator 10 and are then individually inserted into another two adjacent W-phase slots 16w which are situated apart from the first two adjacent W-phase slots 16w with two adjacent U-phase slots 16u and two adjacent V-phase slots 16v interposed therebetween from the other axial end side towards the axial end side of the stator 10 via the insulation members 12. By winding the wires 20 in this way, a coil end portion 17w of the W-phase coil 13w passes the other axial end side or the axial end side which is opposite to the axial end side or the other axial end side where coil end portions 17u, 17v of the U-phase coil 13u and V-phase coil 13v intersect. Thereafter, wires 20 are individually inserted into W-phase slots 16w in a similar fashion through wave-winding so as to extend the full circumference of the stator core 11 to thereby form a first turn 13w1 of the W-phase coil 13w.

Similarly, a second turn 13u2 of the U-phase coil 13u, a second turn 13v2 of the V-phase coil 13v, a second turn 13w2 of the W-phase coil 13W, a third turn 13u3 of the U-phase coil 13u, . . . are wound around the stator core 11 in that order.

In this way, by disposing the U-phase coil 13u, the V-phase coil 13v and the W-phase coil 13w alternately every turn, the wirings 20 are wave wound around the slots 16, while in the U-phase coil 13u, the V-phase coil 13v and the W-phase coil 13w, the coil end portions (17u and 17w, 17v and 17w or 17w) of the coils of the two phases (13u and 13w, 13v and 13w) are disposed so as to be aligned in the radial direction as is shown in FIG. 12. By disposing the U-phase coil 13u, the V-phase coil 13v and the W-phase coil 13w alternately every turn in the order of turns of the coils of the respective phases, compared with the conventional coils, the volumes of the coil end portions 17u, 17v, 17w become small, whereby the coil volume is reduced.

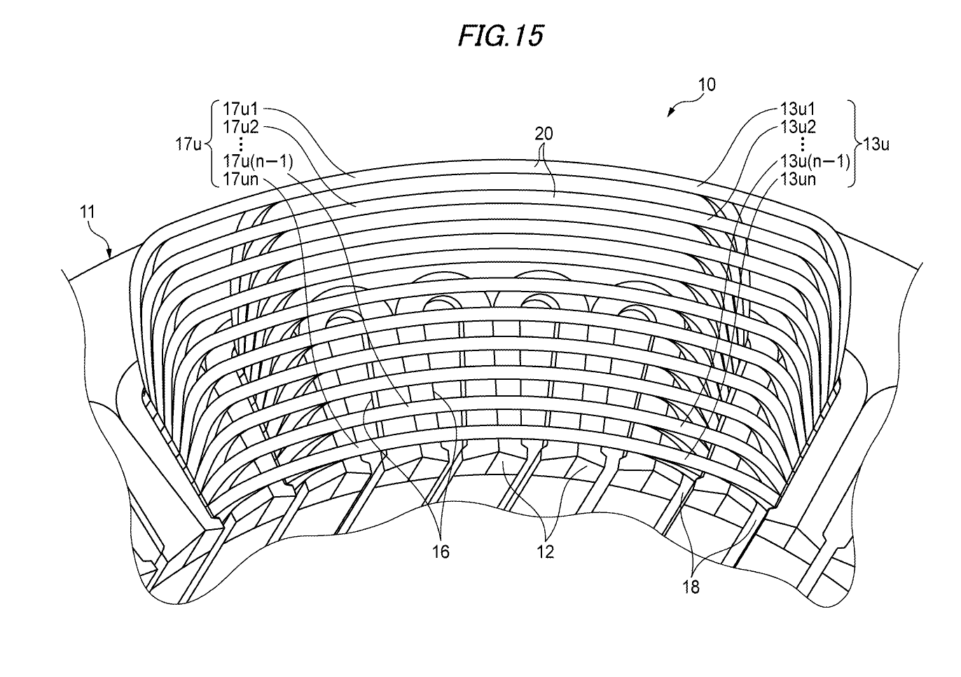

To facilitate the understanding this, FIG. 15 shows only the U-phase coil 13u. The respective coil end portions 17u, 17v, 17w of the three phases are arranged so that the first turn 13w1 of the W-phase coil 13w and the first turn 13v1 of the V-phase coil 13v are inserted in a radial gap between the first turn 13u1 and the second turn 13u. Thereafter, this becomes true with respect to each turn (between the (n−1)th turn and the nth turn).

Because of this, the coil end portions 17u are formed so as to be displaced slightly radially outwards every turn to thereby ensure radial gaps. The displacement amount becomes gradually smaller as the coil end portions 17u are displaced from an inside diameter side towards an outside diameter side of the stator core 11. In addition, the displacement amount of the coil end portions 17u may be such that the coil end portions 17u which are disposed from a substantially central portion of a radial thickness of the stator core 11 to the outside diameter side thereof are displaced radially outwards, while the coil end portions 17u which are disposed from the substantially central portion to the inside diameter side are disposed radially inwards. This becomes true with respect to the V-phase coil end portions 17v and the W-phase coil end portions 17w.

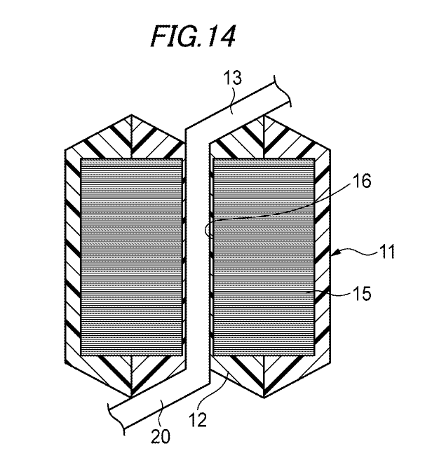

As is shown in FIG. 14, the wires 20 which make up the coils 13u, 13v, 13w of the three phases are bent along the shape of the insulation member 12 and are wave wound around the slots 16u, 16v, 16w of the three phases in the way described above. By the wires 20 being so wound, the stator core 11, the insulation members 12 and the coils 13u, 13v, 13w of the three phases are fixed physically to each other by means of tensions of the wires. Here, the “fixed physically by means of tensions” means a state in which there is almost no change in the relative positional relationship among the stator core 11, the insulation members 12 and the coils 13. Consequently, the necessity of the lacing treatment and the varnish treatment, which are implemented with respect to the conventional stator, is now obviated, and it will be sufficient that a simple fusing heat treatment employing a self-fusing wire is implemented on the resulting coils as required.

The tension of the wire 20 is preferably equal to or smaller than an allowable elastic stress of the wire 20. Alternatively, a stress exerted on the insulation member 12 by means of the tension of the wire 20 is preferably equal to or smaller than an allowable compression strength thereof. More preferably, both the requirements are met at the same time. The settings ensure that no defect resulting from the tension of the wire 20 is generated such as the plastic deformation or failure of the wound wire 20 and the plastic deformation of the insulation member 12.

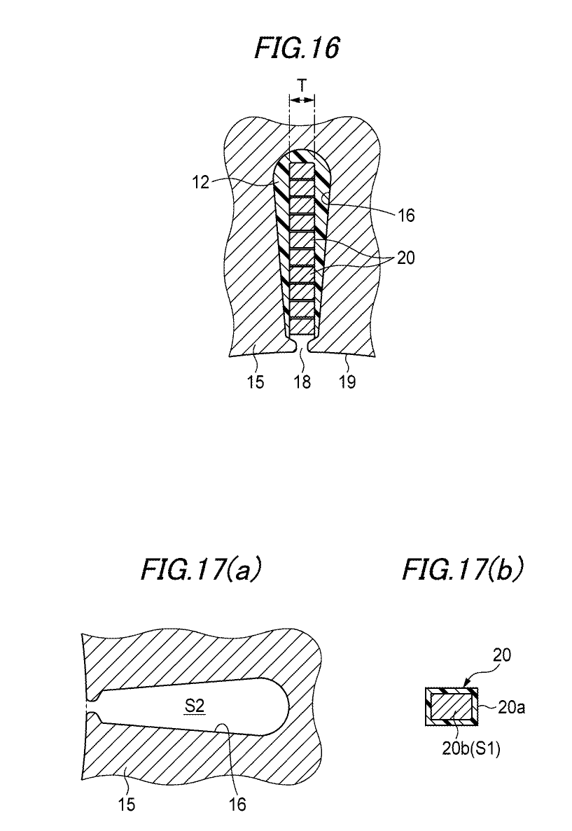

As is shown in FIG. 16, wires 20 are disposed in each slot 16 via the insulation members 12, and the V-, U- and W-phase coil end portions 17u, 17v, 17w are disposed alternately in the radial directions as is shown in FIG. 12 in accordance with the order of turns thereof. Thus, there is caused no such situation that the coil of one of the three phases that has already been wound around interrupts the coils of the other phases when they are attempted to be wound around. Thus, the wires 20 can be wound with an increased space factor S of the coils 13. The space factor S of the stator 10 of this embodiment can be 40% or larger, and in the case of the state shown in FIG. 16, a space factor of substantially 55% can be ensured. In addition, the wires 20 of this embodiment have a substantially rectangular section whose width is substantially equal to a circumferential space T between the insulation members 12 in the slot 16. Because of this, the wires 20 can be aligned within the slot 16 with almost no gap, whereby the space factor S is increased further. Here, the “space factor S” is defined as a ratio of a total of sectional areas S1 of electric conductor portions 20b, which result by removing insulating surface coatings 20a from the wires 20, and a sectional area S2 of the slot 16.

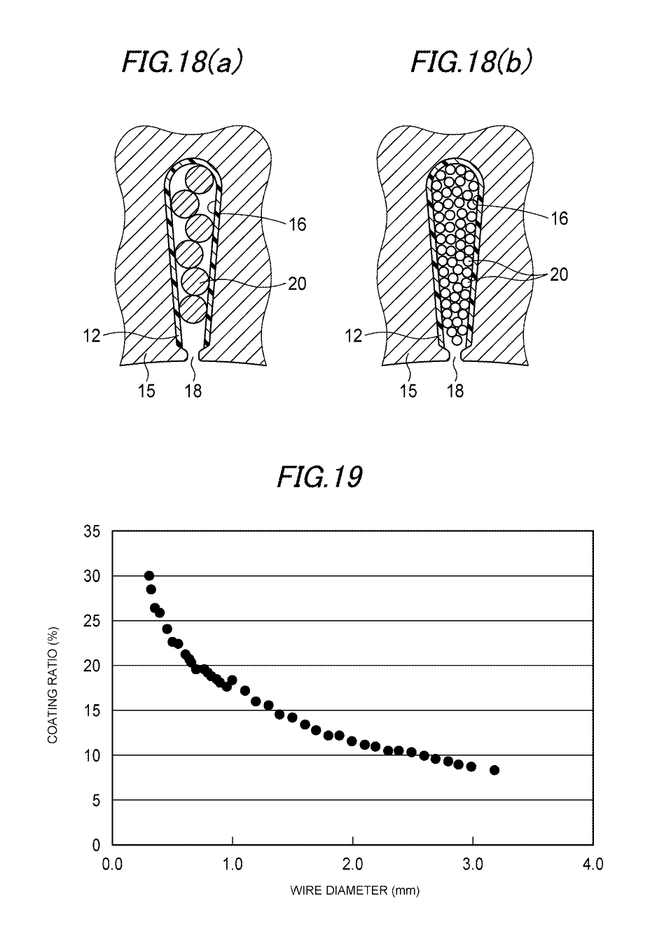

The sectional shape of the wire 20 is not limited to that shown in FIG. 16, and wires 20 having circular sections like those shown in FIGS. 18(a) and 18(b) may be adopted. When comparing thin wires 20 inserted in a slot 16 with thick wires 20 inserted in a slot 16 by reference to FIGS. 18(a) and 18(b), although a space factor S produced by the thin wires 20 appears to be higher than a space factor S produced by the thick wires 20 at a glance, as is indicated by a relationship shown in FIG. 19 between wire diameter and insulating surface coating ratio with the same insulating surface coating thickness, as the wire diameter increases, the sectional area ratio of an insulating surface coating 41 becomes smaller, and the thick wire is advantageous over the thin wire with respect to space factor S. In addition, with the same space factor, the thickness of the insulating surface coating 41 can be made thick by increasing the wire diameter of a conductor wire 40 which is a single wire, and hence, the thick wire is advantageous over the thin wire with respect to insulation performance, which is increased. Further, compared with the wires 20 having the circular section shown in FIG. 18(a), the wires 20 having the rectangular section shown in FIG. 16 can reduce gaps that would be produced within the slot 16.

In addition, an insulation treatment is applied to a normal wire by an enamel coating of the order of 40 to 50 μm. However, a voltage that can be used with an enamel-coated electric wire is generally said to be 500V or smaller, and when the voltage exceeds 500V, a partial discharge is started, leading a fear that deterioration in insulation is generated. In the case of motors for electric vehicles which tend to use higher voltages, in also consideration of surge voltage, a withstand voltage of the order of 1000V is required. Because of this, although it is considered that interphase insulation is implemented by disposing an insulation paper between the wires 20 of the coils 13u, 13v, 13w of the three phases, an insulation paper inserting step is necessary when a stator 10 is manufactured, leading to a problem that the manufacturing work becomes complex.

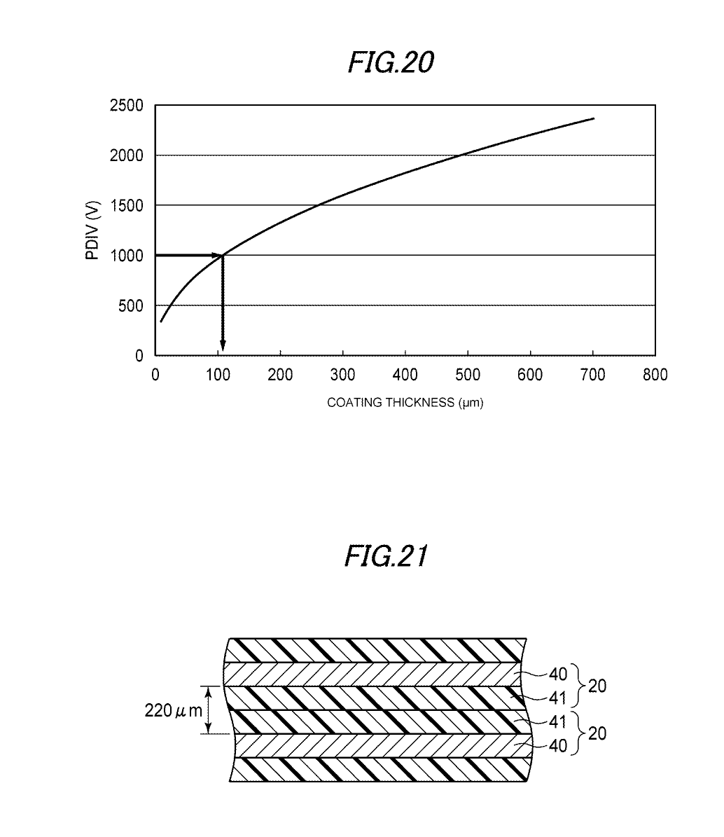

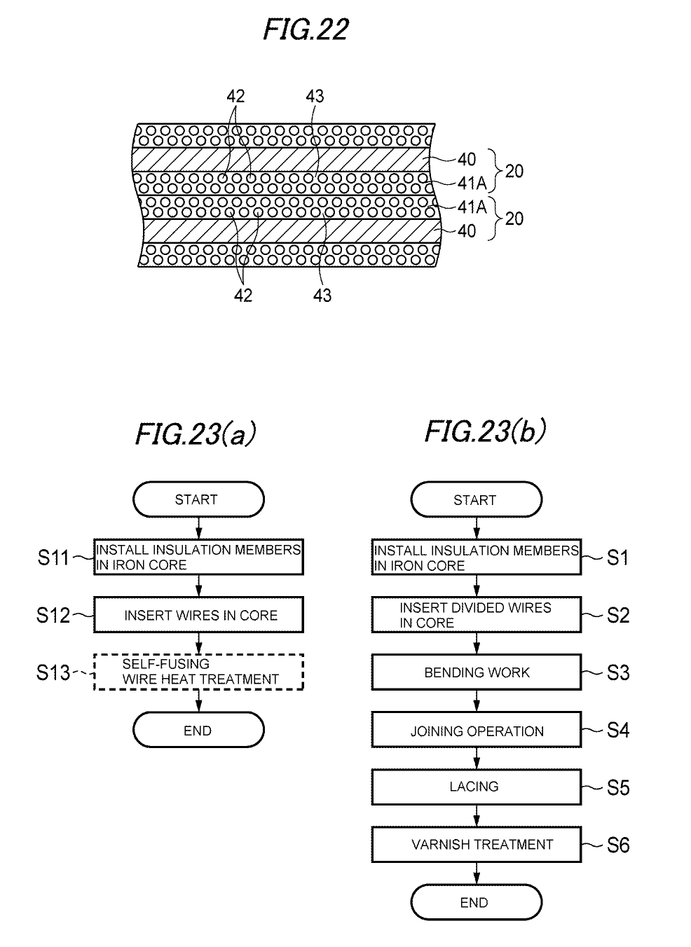

FIG. 20 is a graph showing a relationship between insulating surface coating thickness based on the Dakin expression and PDIV (Partial Discharge Initiating Voltage (withstand voltage)). It is seen from this graph that an insulating surface coating thickness of substantially 110 μm is necessary to make it happen that PDIV is 1000V. Consequently, as is shown in FIG. 21, by baking an insulating surface coating 41 such as an enamel coating having a thickness of 110 μm or larger to the wire 20 as an insulating surface coating to be applied to the wire 20, an inter-conductor distance of 220 μm by the insulating surface coatings 41 can be ensured between conductor wires 40. By this configuration, the suppression of partial discharge can be implemented by the insulating surface coatings 41 of the wires 20 only without implementing the interphase insulation by disposing the insulation paper between the wires 20, this facilitating the manufacturing coils 13. In addition, as the insulating surface coating 41, an insulation tape or insulation film which has the same performance as that of the enamel surface coating may be wound around to a thickness of 110 μm or larger.

In addition, as is shown in FIG. 23, a composite insulating surface coating 41A may also be used as an insulating surface coating. In the composite insulating surface coating 41, inorganic particles 42 are dispersed within a resin 43, and the deterioration speed of insulation performance by partial discharge can be suppressed by the inorganic particles 42, thereby making it possible to extend the insulation life. In addition to this, an inorganic insulating surface coating having high anti-discharge properties may be used as another insulating surface coating. Inorganic materials such as glass, mica, Nomex and Kapton can be formed into a tape or a film for use as an inorganic insulating surface coating by being wound directly around a conductor (a single wire) 40 or around a conductor wire 40 coated with an enamel surface coating.

Next, based on FIGS. 23(a) to 27, a manufacturing method of the motor stator 10 of the embodiment will be described. FIGS. 23(a) and 23(b) show flowcharts of manufacturing methods in which a manufacturing process in FIG. 23(a) and a conventional manufacturing process in FIG. 23(b) are compared. As is shown in FIG. 23(b), according to the conventional manufacturing method, after insulation members are installed in slots in a stator core (an iron core) (step S1), wires which are separated by the insulation members are inserted into the stator core (step S2). Then, bending work is carried out of bending the separated wires (step S3), and following this, a joining operation is carried out of joining together end portions of the separated wires which lie adjacent to each other (step S4). Then, a lacing operation is carried out of fastening the coils with a lacing string (step S5), and then, a varnishing operation is carried out of impregnating the coils with a varnish and setting the varnish in the coils so as to fix together the stator core, the insulation members and the coils (step S6). In this way, according to the conventional manufacturing method, the motor stator is manufactured through the process of the six steps.

In contract with this, according to the motor stator manufacturing method according to the embodiment, as is shown in FIG. 23(a), the manufacturing process can be reduced to two steps: a step (step S11) of installing insulation members 12 in slots in a stator core (an iron core) 11 and a step (step S12) of winding wires 20 around the stator core 11 via the insulation members 12, whereby not only a reduction in material used but also a remarkable reduction in manufacturing time can be realized to thereby suppress the manufacturing costs. In addition, in the case of a self-fusing wire being used as a wire 20, the fixing of the resulting coils can be simplified by fixing the wires 20 in a simplified fashion by implementing a heat treatment step (step S13).

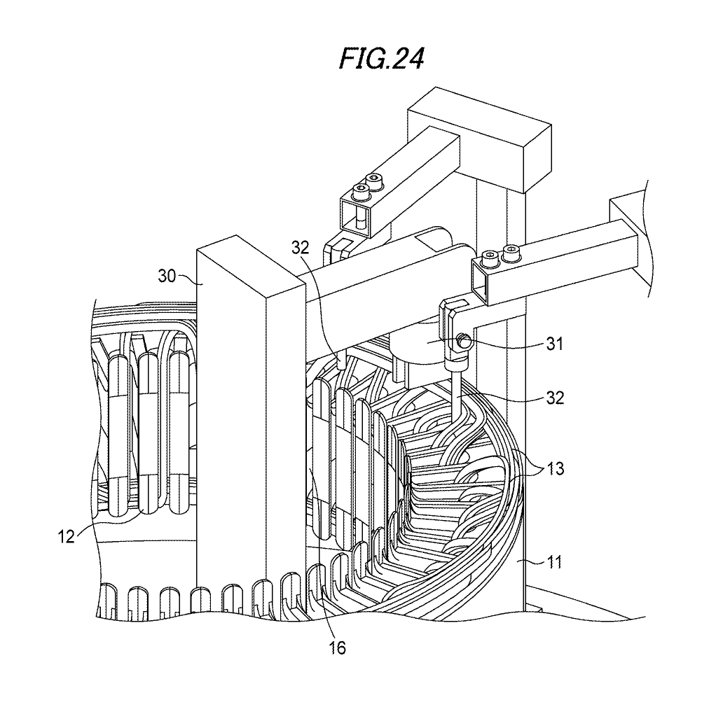

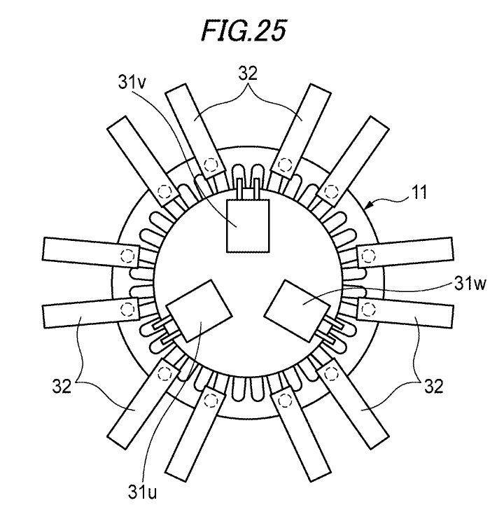

Specifically describing the manufacturing process of the embodiment, as is shown in FIGS. 24 and 25, the stator core 11 is disposed horizontally, and wires 20 are wave wound around the stator core 11 by three U-, V- and W-phase nozzles 31 which each discharge two wires 20 and a plurality of hooks 32 which hold wires 20 so discharged at predetermined positions.

Three nozzles 31 are provided which include a U-phase nozzle 31u which discharge two wires 20 which make up a U-phase coil 13u, a V-phase nozzle 31v which discharges two wires 20 which make up a V-phase coil 13v and a W-phase nozzle 31w which discharges two wires 20 which make up a W-phase coil 13w and which are disposed on an inside diameter side of the stator 11. The nozzles 31u, 31v, 31w can each be moved in a vertical direction and a radial direction of the stator core 11 while discharging two wires 20 by being guided by a corresponding nozzle guide rail 30.

There are disposed 24 hooks 32 in total; 12 hooks 32 are disposed at each of both the axial end sides of the stator core 11. The hooks 32 lock wires 20 which are discharged from the nozzles 31u, 31v, 31w of the three phases in predetermined positions and hold the wires 20 radially outwards of the stator core 11.

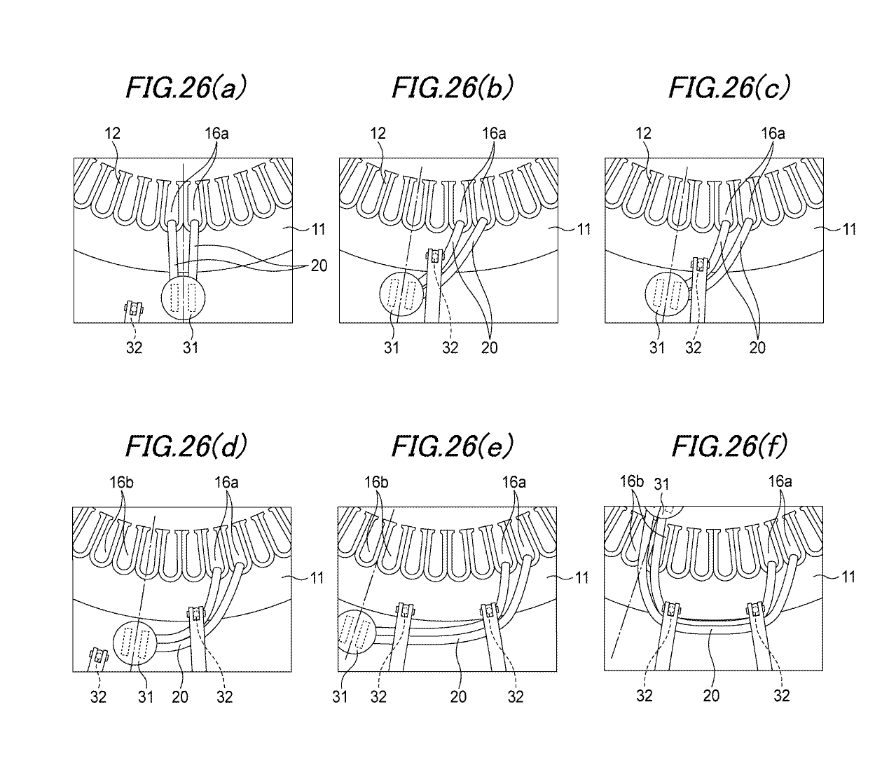

In a specific step of distributed-winding (wave-winding) wires 20 around the stator core 11, as is shown in FIG. 26(a), two wires 20 are individually inserted into a pair of first slots 16a via the insulation members 12 from the axial end side (from a lower end in the figure) towards the other axial end side (an upper end in the figure) of the stator core 11. Then, the wires 20 which are pulled out from the first slots 16a are locked by the hook 32 which is moved radially inwards (FIG. 26(b)) and holds the wires 20 radially outwards of the first slots 16a with a tension applied to the wires 20 (FIG. 26(c)).

In applying a tension to the wires 20, when the wires 20 are locked by the hook 32 and are then pulled radially outwards, the wires 20 which are inserted in the slots 16 are unbent radially inwards, leading to a fear that the space factor is reduced. In this case, a wire pressing mechanism may be provided so that the wires 20 are wound around while the wires 20 which are unbent in the corresponding slots 16 are pressed radially inwards to correct the unbending thereof.

Next, with the wires 20 kept locked by the hook 32, the stator core 11 is rotated by a predetermined angle together with the hook 32 so that the wires 20 are located at a second pair of second slots 16b into which the wires 20 are to be inserted next. By so rotating the stator 11, the wires 20 which are discharged from the nozzle 31 are disposed along an outer circumference side of the stator core 11 (FIG. 26(d)). Here, with the wires 20 held radially outwards of the second slots 16b (FIG. 26(e)), the wires 20 are inserted into the second slots 16b via the insulation members 12 from the other axial end side (the upper end) towards the axial end side (the lower end) of the stator core 11 (FIG. 26(f)).

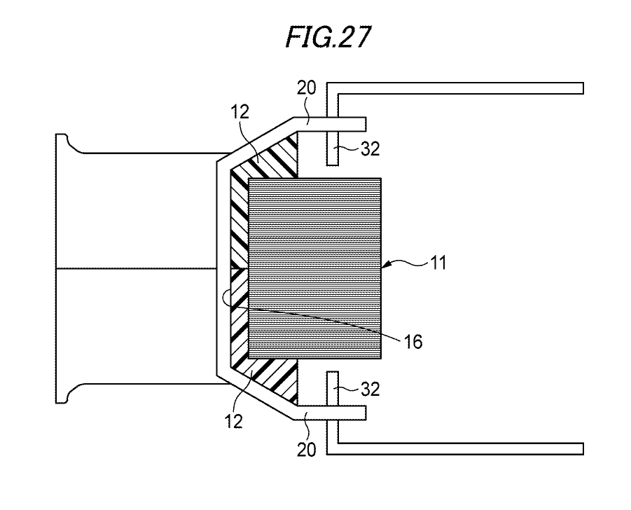

Thereafter, similarly, as is shown in FIG. 27, the wires 20 which are pulled out of the second slots 16b are locked by the hook 32 and are held radially outwards of the second slots 16b while a tension is applied to the wires 20. Then, the stator core 11 is rotated by the predetermined angle together with the hook 32 so that the wires 20 are moved to be located at a pair of third slots. The wires 20 which are discharged from the nozzle 31 and are disposed along the outer circumferential side of the stator core 11 are held radially outwards of the third slots by the hook 32. By repeating the steps described above, the coil 13 of one of the three phases (for example, the U-phase coil 13u) is wave wound around the stator core 11.

The series of operations are performed simultaneously by the three nozzles 31 of the U-phase nozzle 31u, the V-phase nozzle 13v and the W-phase nozzle 13w, whereby the three coils 13 of the U-phase coil 13u, the V-phase coil 13v and the W-phase coil 13w are formed while being disposed alternately in accordance with the order of turns.

Thus, as has been described heretofore, according to the motor stator 10 according to the embodiment, the wires 20 which are distributed-wound in the slots 16 via the insulation members 12 so as to form the coils 13 of the plurality of phases are each formed of the single wire and are disposed within the insulation members 12 while being tensioned so that the stator core 11, the insulation members 12 and the coils 13 are physically fixed together. Therefore, the lacing operation and the vanishing operation that would otherwise be implemented after the wires 20 have been wound around the stator core 11 can be avoided or simplified, which can simplify the manufacturing process, whereby the manufacturing costs of the motor stator 10 can be suppressed.

In addition, the single wire is coated with the insulating surface coating 41 of 110 μm or thicker. Therefore, even in the event that a high voltage is applied to the coils 13 so as to attain the reduction in size and the increase in performance of the motor, the insulation distance between the wires 20 of the different phases can be ensured.

Additionally, the single wire is made up of the conductor wire 40 having the substantially rectangular section and the insulating surface coating 41. Therefore, the wires 20 can be disposed so as to be aligned in the slots 16, which increases the space factor S, thereby making it possible to increase the motor efficiency. In addition, with the same space factor S, the thickness of the insulating surface coating 41 can be increased, the insulation performance being thereby increased.

Further, the coil end portions 17u, 17v, 17w of the coils 13u, 13v, 13w of the three phases are disposed alternately on the stator core 11 in accordance with the order of turns thereof. Therefore, the coil volume is reduced, which suppresses the coil resistance and copper loss, thereby making it possible to increase the motor efficiency. In addition, a reduction in weight and size of the motor can be realized.

Furthermore, the insulation member 12 is the elastic resin member. Therefore, in forming the coils 13 of the plurality of phases, even in the event that the wires 20 are disposed in the insulation members 12 while being tensioned, there is no fear that the wires 20 are damaged, whereby the predetermined motor performance is maintained.

In addition, the tension applied to the wire 20 is equal to or smaller than the allowable elastic stress of the wire 20 and/or equal to or smaller than the allowable compression strength of the insulation member 12. Therefore, in forming the coils 13 of the plurality of phases, even in the event that the wires 20 are distributed-wound around the insulation members 12 while being tensioned, there is caused no such situation that the wires 20 and the insulation members 12 are plastically deformed, whereby the predetermined motor performance is maintained.

Further, the opening portions 18 of the slots 16 are opened in the inner circumferential surface 19 of the stator core 11. Therefore, the motor stator 10 of this embodiment can preferably be used as a motor stator for an inner rotor type motor.

Furthermore, the space factor S of the coils 13 disposed in the slots 16 is 40% or smaller. Therefore, an increase in motor efficiency can be realized.

In addition, the coils 13 of the plurality of phases are made up of the coils 13 of the three phases of U-, V- and W-phases. The coils 13 of the three phases are formed by wave-winding the wires 20 in the plurality of slots 16 so that the coil end portions 17 of the coils 13 of the two phases are aligned in the radial direction. Therefore, the coil volume can be reduced, thereby making it possible to increase the motor efficiency by suppressing the coil resistance and copper loss. In addition, a reduction in weight and size of the motor can be realized.

### Third Embodiment

Next, a motor stator according to a third embodiment of the invention will be described.

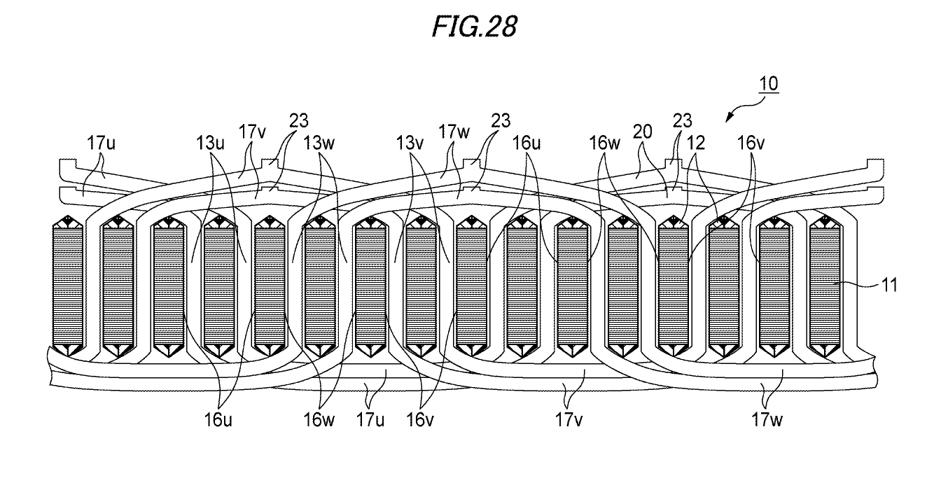

FIG. 28 is an exemplary diagram showing a wound state of wires of a motor stator of the third embodiment. In the third embodiment, coils 13 of three phases are formed by joining (fastening) together distal ends of wires 20, which are each formed of a single wire and are divided in advance. The third embodiment has the same configuration as that of the second embodiment excluding a configuration in which joined portions 23 exist on an axial end side or the other axial end side of a stator core 11. Consequently, a manufacturing method of this embodiment will be described in detail, while like reference numerals or corresponding reference numerals will be given to like portions to those of the motor stator 10 of the second embodiment, so that the description thereof will be omitted.

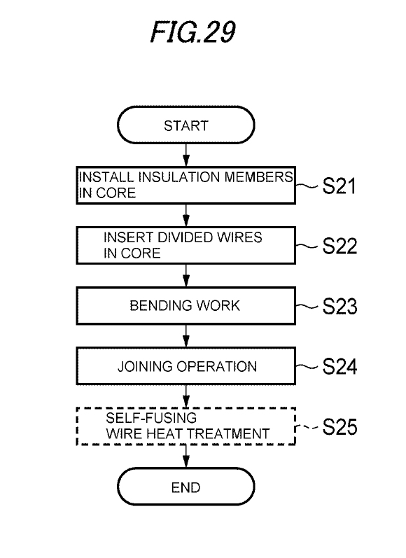

As is shown in FIG. 29, a manufacturing method of a motor stator 10 of this embodiment can be reduced to a process including four steps of installing insulation members 12 in slots 16 in a stator core 11 (an iron core), inserting divided wires 20A in the slots 16 in the stator core 11 via the insulation members 12 (step S22), bending the divided wires 20A (step S23), and joining together end portions of adjacent divided wires 20A of the same phase (step S24). Thus, not only can material used be reduced, but also manufacturing time can be reduced remarkably, thereby making is possible to suppress the manufacturing costs. Note that in the case of a self-fusing wire being used as a wire 20, the fixing of the resulting coils can be simplified by fixing the wires 20 in a simplified fashion by implementing a heat treatment step (step S25).

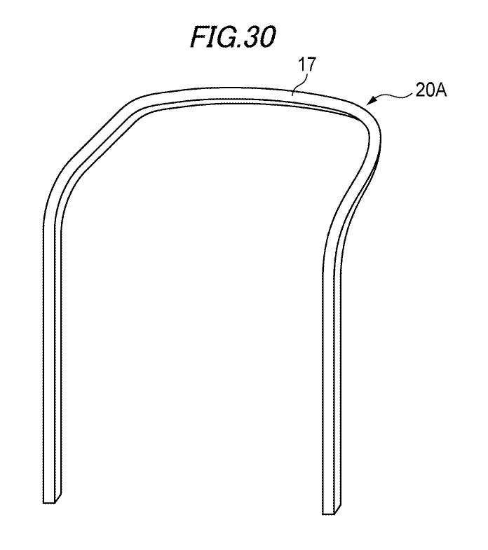

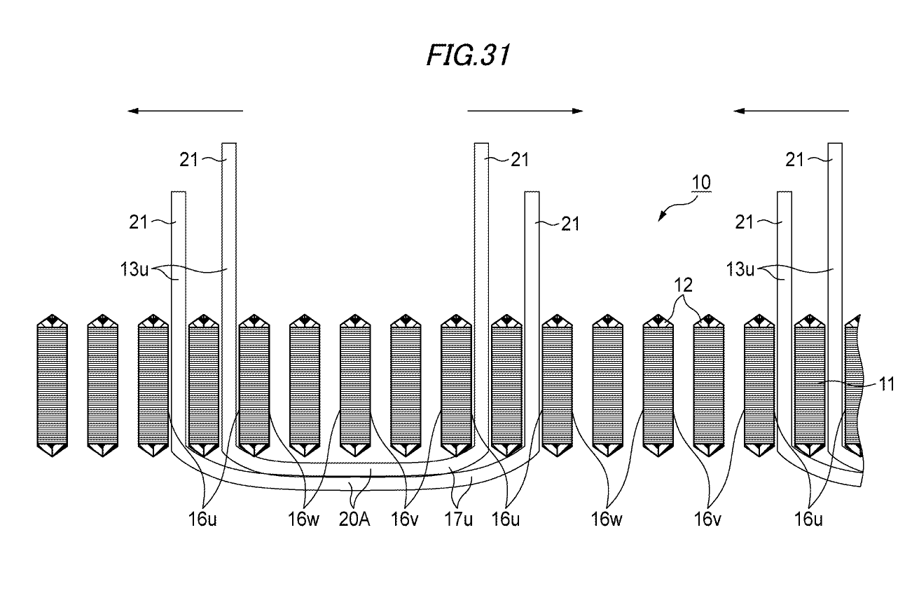

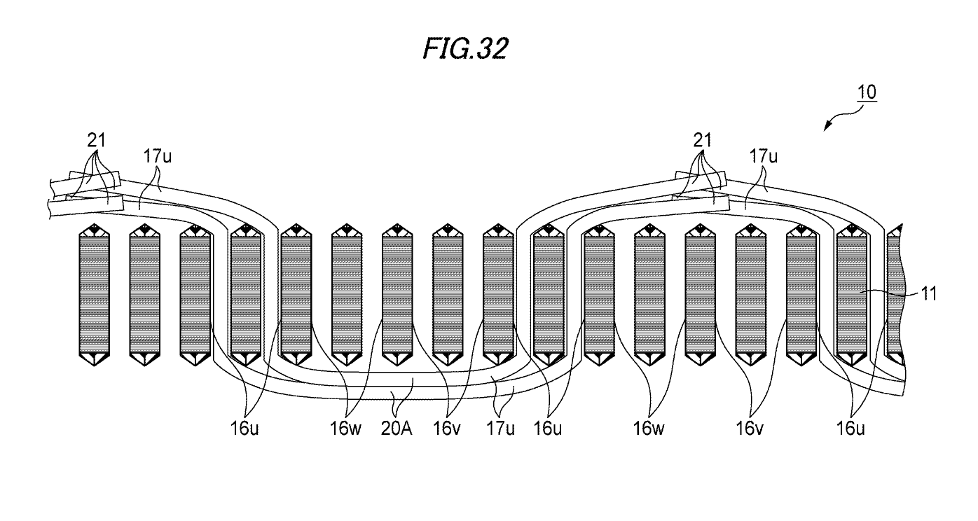

Specifically, at first, a plurality of wires 20A, which are each bent into a substantially U-shape as is shown in FIG. 30 and which have coil end portions 17 which are formed to be displaced radially outwards differently, are inserted, as is shown in FIG. 31, into two sets of two U-phase slots 16u which are disposed spaced apart from each other with two V-phase slots 16v and two W-phase slots 16w interposed therebetween via the insulation members 12. Following this, as is indicated by arrows in FIG. 31, one end side of the wire 20 is bent in one circumferential direction and the other end side thereof is bent in the other circumferential direction, whereby distal ends 21 of the adjacent wires 20A of the same phase are disposed close to each other as is shown in FIG. 32.

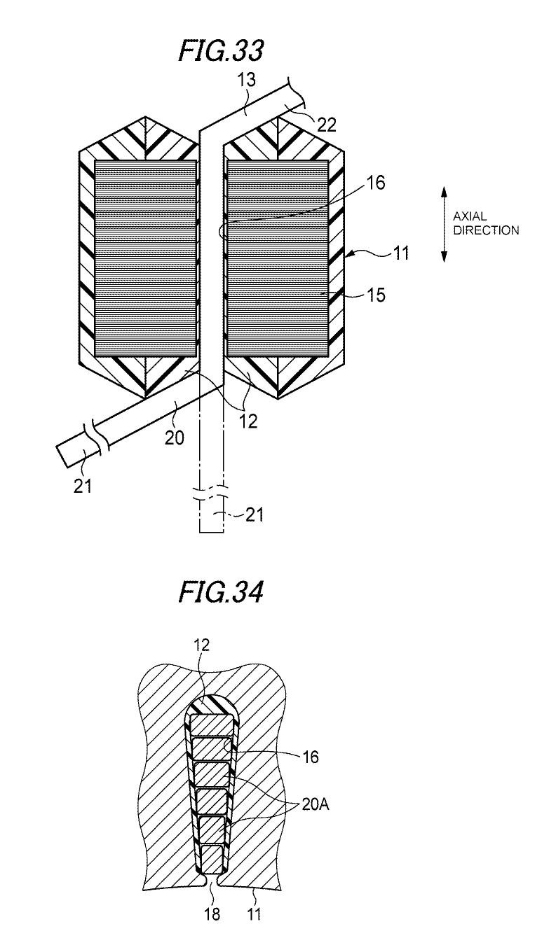

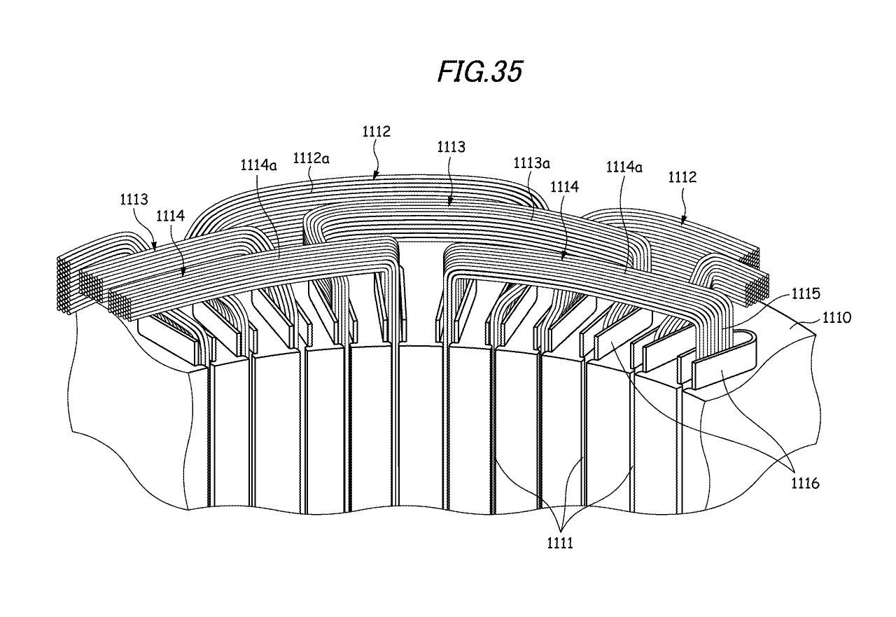

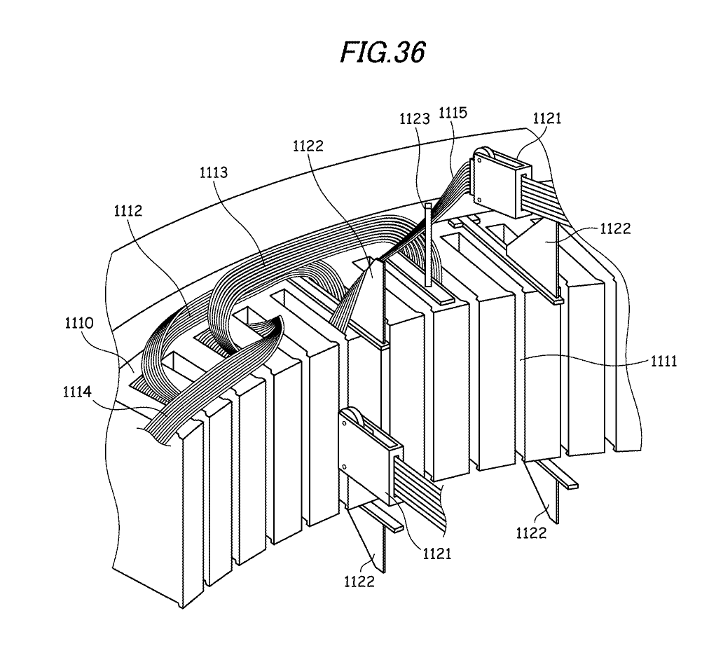

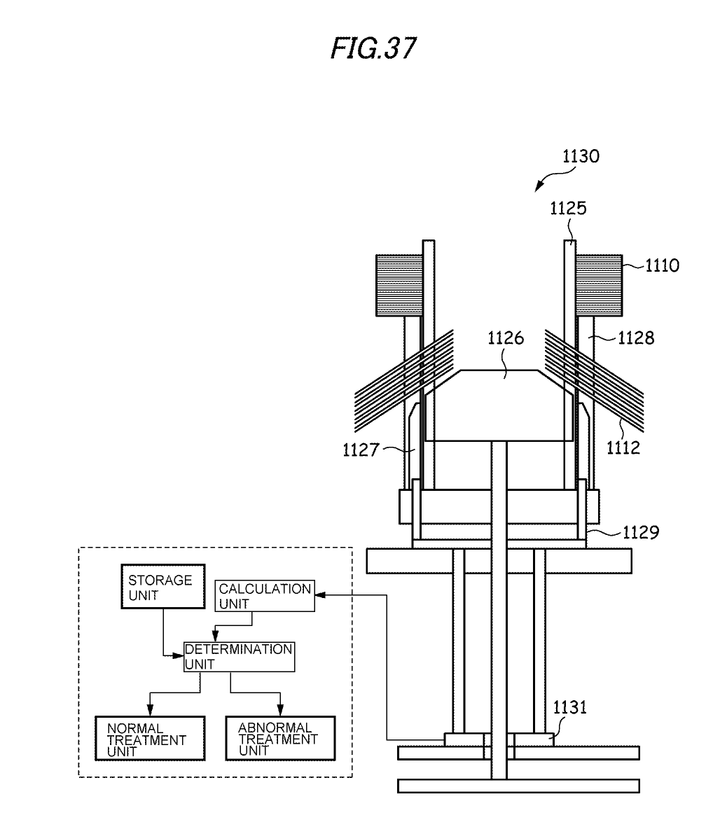

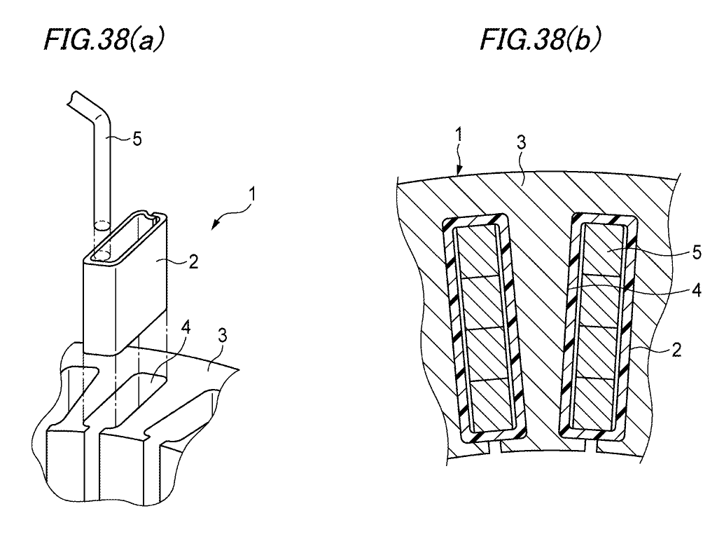

As this occurs, as is shown in FIG. 16, the wire 20A has a width which is substantially equal to a circumferential space T between the insulation members 12 in the slot 16. Therefore, the wires 20A inserted in the slot 16 are fixed in place in the circumferential direction by the insulation members 12. In addition, at the same time, the coil end portions 17 which are formed in advance are brought into engagement with the insulation members 12 as is shown in FIG. 33, whereby the wires 20 are also fixed in place in an axial direction. Namely, a tension is applied to the wire 20A by bending the wire 20A, whereby the wire 20 is physically fixed to the stator core 11. Then, the distal ends of the adjacent wires 20 of the same phase are joined together to form joined portions 23, whereby a first run 13u1 of the U-phase coil 13u is formed.

By winding the V-phase coil 13v and the W-phase coil 13w are wound in the same way as that described above, a first turn 13u1 of the V-phase coil 13v and a first turn 13w1 of the W-phase coil 13w are formed. Similarly, a second turn 13u2 of the U-phase coil 13u, a second turn 13v2 of the V-phase coil 13v, a second turn 13w2 of the W-phase coil 13w, a third turn 13u3 of the U-phase coil 13u, . . . are wound around the stator core 11 sequentially in that order, and finally, as is shown in FIG. 12, three coils 13 of the U-phase coil 13u, the V-phase coil 13v and the W-phase coil 13w are disposed alternately on the stator core 11 in accordance with the order of turns thereof.

Also in the motor stator 10 formed in the way described above, since the coil end portions 17 are formed so as to be displaced radially outwards differently in accordance with the order of turns when the wires 20A are bent into the substantially U-shape in advance, a space is formed between the coil end portion 17 of the first turn and the coil end portion 17 of the second turn which enables the coil end portion 17 of the different phase to be inserted thereinto. In addition, since the wires 20A of the three phases are disposed within the insulation members 12 while being tensioned, the stator core 11, the insulation members 12 and the coils 13u, 13v, 13w of the three phases are physically fixed together by means of the tension applied to the wires 20A, whereby the lacing treatment and the varnish treatment which would otherwise be necessary can be avoided or simplified.

FIG. 34 is a sectional view showing a state in which single wires having difference sectional shapes are inserted into the slot 16. According to this embodiment, as is shown in FIG. 34, wires 20A (single wires) having widths which differ every turn or in accordance with the order of turns are used to be wound around the stator core 11 by employing insulation members 12 having a circumferentially uniform thickness, whereby a space defined between the slot 16 and the wires 20A can be minimized, thereby making it possible to increase the space factor S further.

With a view to preventing a reduction in motor efficiency, in the wires 20A, although sectional shapes of conductor wires 40 become different, sectional areas thereof desirably remain constant so that electric resistance every turn becomes constant. In addition, although the conductor wire 40 can have an arbitrary sectional shape, it is good that the conductor wire 40 has a flat angular shape so as to increase the space factor S.

Thus, as has been described heretofore, according to this embodiment, the stator can be manufactured which employs the wires 20 whose sectional shapes differ every turn or in accordance with the order of turns. In addition, this embodiment is effective in application for a wire which has a large sectional shape and high bending rigidity.

Thus, as has been described heretofore, according to the motor stator 10 according to this embodiment, the plurality of wires 20A which are formed into the substantially U-shape are inserted into the slots 16, the distal ends of the wires 20A are bent to apply the tension to the wires 20A, and the wires 20A are disposed within the insulation members 12 while being tensioned. Therefore, the stator core 11, the insulation members 12 and the coils 13 can be physically fixed together, whereby the lacing treatment and the varnish treatment which would otherwise be necessary can be avoided or simplified, and this can simplify the manufacturing process, the manufacturing costs of the motor stator 10 being thereby suppressed.

In addition, the coils 13 are formed by inserting the plurality of wires 20A which are formed into the substantially U-shape into the slots 16 and joining together the distal ends 21 of the wires 20A. Therefore, the coils 13 can easily be manufactured by use of the wires 20A which are each made up of the single wire.

Additionally, the conductor wires 40 are constant in sectional area but differ in sectional shape, and therefore, the wires 20A can be disposed so as to be aligned in the slots 16 so as to minimize the space defined, which increases the space factor S, thereby making it possible to increase the motor efficiency.

Further, since the insulation member 12 is the elastic resin member, in forming the coils 13 of the plurality of phases, even in the event that the wires 20 are distributed in the insulation members 12 while being tensioned, there is caused no fear that the wires 20 are damaged, whereby the predetermined motor performance is maintained.

In addition, since the tension applied to the wires 20 is equal to or smaller than the allowable elastic stress of the wire 20 and/or equal to or smaller than the allowable compression strength of the insulation member 12, in forming the coils 13 of the plurality of phases, even in the event that the wires 20 are distributed in the insulation members 12 while being tensioned, there is caused no such situation that the wires 20 and the insulation members 12 are plastically deformed, whereby the predetermined motor performance is maintained.

Furthermore, since the opening portion 18 of the slot 16 is opened in the inner circumferential surface 19 of the stator core 11, the stator motor of the embodiment can preferably be used as a motor stator 10 for an inner rotor type motor.

The invention is not limited to the embodiments that have been described heretofore and hence can be modified or improved as required.

For example, in the embodiments, while the motor stator is described in which the wires are distributed-wound through wave-winding, the invention is not limited thereto but can also be applied to a motor stator in which wires are lap wound, for example.

In addition, in the embodiments described above, while the wires are wound around each of the pairs of slots as slots for the coil of the same phase, which are aligned adjacent in the circumferential direction at intervals of four slots, the wires may be wound around each of slots as slots for the coil of the same phase which are aligned at intervals of two slots. Alternatively, the wires may be wound around each of a predetermined number of slots as slots for the coil of the same phase which are aligned adjacent in the circumferential direction with slots for the other phases interposed therebetween.

In accordance with the above embodiments, a motor stator 10, 110 may include: a stator core 11, 111 having a plurality of slots 16, 116; insulation members 12, 112 which are disposed in the plurality of slots; and coils of a plurality of phases 13u, 13v, 13w, 113u, 113v, 113w which are respectively formed by distributed-winding wires 20, 20A, 120 in prescribed slots of said plurality of slots disposed spaced apart at intervals of a predetermined number of slots via the insulation members. The wires may be disposed within the insulation members in a condition that tensions are applied to the wires. The stator core, the insulation members and the coils may be physically fixed together by the tensions of the wires.

According to this structure, the lacing treatment and the varnish treatment which would otherwise be necessary after the wires are wound can be avoided or simplified, which can simplify the manufacturing process, whereby the motor stator manufacturing costs are suppressed.

Each of the wires 120 may be made up of a plurality of strands 120′.

Each of the wires may be made of a single wire 20, 20A.

The single wire may be coated with an insulating surface coating 41, 41A of 110 μm or larger.

According to this structure, since the high performance can be attained, even in the event that a high voltage is applied to the coils, an insulation distance between the wires of the different phases can be secured in the ensured fashion.

The single wire may be coated with a composite insulating surface coating 41A in which inorganic particles 42 are dispersed in a resin 43.

According to this structure, even in the event that a discharge phenomenon is generated between the wires of the different phases of the coils, the deterioration of the insulating surface coating can be suppressed, whereby the insulation life can be extended.

The single wire may be coated with an inorganic insulating surface coating.

According to this structure, the resistance to discharge in the insulating surface coating can be increased, whereby an extension in insulation life can be realized.

The single wire may comprise a conductor wire 40 having a substantially rectangular section and an insulating surface coating which covers an outer surface of the conductor wire.

According to this structure, the wires can be disposed so as to be aligned within the slots, and this increases the space factor, whereby the motor efficiency can be increased. In addition, with the same space factor, the thickness of the insulating surface coating can be increased, whereby the insulation performance is increased.

The conductor wire may have a sectional area which is constant and a sectional shape which differs in accordance with the order of turns.

According to this structure, the wires can be disposed to be aligned within the slots so as to minimize the gaps defined therein, and this increases the space factor, whereby the motor efficiency can be increased.

The coils may each be formed by inserting a plurality of wires 20A each formed into a substantially U-shape into the slots and joining together distal ends 21 of the wires.

According to this structure, the coils can easily be manufactured by use of the wires which are each made of the single wire having high bending rigidity.

Coil end portions 17u, 17v, 17w, 117u, 117v, 117w of the coils of the plurality of phases may be disposed alternately on the stator core in accordance with the order of turns of the coils of the plurality of phases.

According to this structure, the coil volume is reduced, and the coil resistance and copper loss are suppressed, whereby the motor efficiency can be increased. In addition, a reduction in weight and size of the motor can be realized.

The insulation member may be an elastic resin member 12, 112.

According to this structure, in forming coils of a plurality of phases, even in the event that the wires are distributed-wound in the insulation members while being tensioned, there is caused no fear that the wires are damaged, whereby the predetermined motor performance is maintained.

A tension applied to each of the wire may be equal to or smaller than an allowable elastic stress of the wire and/or equal to or smaller than an allowable compression strength of the insulation member.

According this structure, in forming coils of a plurality of phases, even in the event that the wires are distributed-wound in the insulation members while being tensioned, there is caused no such situation that the wires and the insulation members are plastically deformed, whereby the predetermined motor performance is maintained.

An opening portion 18, 118 of each of the slots may be opened in an inner circumferential surface 19, 119 of the stator core.

According to this structure, the motor stator can preferably be used as a motor stator for an inner rotor type motor.

A space factor S of the coil disposed within the slot may be equal to or larger than 40%.

According to this structure, an increase in motor efficiency can be realized.

The coils of the plurality of phases may comprise coils of three phases including U-phase, V-phase and W-phase. The coils of the three phases may be formed by wave-winding the wires in the slots so that coil end portions of the coils of the two phases are aligned in a radial direction.

According to this structure, the coil volume can be reduced, and this suppresses the coil resistance and copper loss, whereby the motor efficiency can be increased. In addition, a reduction in weight and size of the motor can be realized.

Moreover, in accordance with the above embodiments, a manufacturing method of a motor stator 10, 110 in which coils of a plurality of phases 13u, 13v, 13w, 113u, 113v, 113w are formed by distributed-winding wires 20, 20A, 120 in a plurality of slots 16, 116 which are provided on a stator core 11, 111 and disposed spaced apart with a predetermined number of slots interposed therebetween, may include the steps of: disposing insulation members 12, 112 in the plurality of slots for establishing electrical insulation between the stator core and the wires; distributed-winding the wires in the plurality of slots; and disposing the wires within the insulation members in a condition that tensions are applied to the wires, and physically fixing the stator core, the insulation members and the coils together.

According to this method, the lacing treatment and the varnish treatment can be avoided or simplified, and the manufacturing process can be simplified, whereby the manufacturing costs of the motor stator are suppressed.

Each of the wires may be made up of a plurality of strands.

The step of distributed-winding may include the steps of: inserting the wires into a corresponding insulation member of a first slot 116a from an axial end side towards the other axial end side of the stator core; holding the wires which are pulled out of the first slot in a position lying radially outwards of the first slot on the other axial end side of the stator core with a tension applied to the wires; rotating the stator core together with the wires by a predetermined angle so that the wires are located at a second slot 116b into which the wires are to be inserted next; holding the wires in a position lying radially outwards of the second slot on the other axial end side of the stator core; inserting the wires in a corresponding insulation member in the second slot from the other axial end side to the axial end side of the stator core; holding the wires which are pulled out of the second slot in a position lying radially outwards of the second slot on the axial end side of the stator core with a tension applied to the wires; rotating the stator core together with the wires by a predetermined angle so that the wires are located at a third slot into which the wires are to be inserted next; and holding the wires in a position lying radially outwards of the third slot on the axial end side of the stator core. The series of steps in the distributed-winding step may be repeatedly executed.

According to this method, the wires can be wave wound in the plurality of slots while being tensioned so that the coil end portions of the coils of the two phases are aligned in the radial direction, whereby not only can the coil fixing treatment be avoided or simplified to thereby simplify the manufacturing process, but also the coil resistance and copper loss can be suppressed to thereby increase the motor efficiency. In addition, a reduction in weight and size of the motor can be realized.

Each of the wires may be made of a single wire 20, 20A.

The step of distributed-winding may include the steps of: inserting the wires which are each formed into a substantially U-shape in advance in the slots; bending distal ends 21 of the wires inserted in the slots in a circumferential direction of the stator core, and applying the tensions to the wires; and joining together the distal ends of the wires of the same phase.

According to this method, even in the event that the wires each made of the single wire having high bending rigidity are used, the coils can easily be manufactured.

The single wire may be coated with a composite insulating surface coating 41A in which inorganic particles 42 are disposed in a resin 43.

According to this method, even in the event that a discharge phenomenon is generated between the wires of the different phases, the deterioration of the insulating surface coating can be suppressed, whereby an extension in insulation life can be realized.

The single wire may be coated with an inorganic insulating surface coating.

According to this method, the resistance to discharge in the insulating surface coating can be increased, whereby an extension in insulation life can be realized.

The wires may each be a flat angular single wire 20A having a sectional shape which differs every turn and a sectional area which is constant.

According to this method, since the wires are each made of the flat angular single wire which has the sectional shape which differs every turn and the sectional area which remains constant, the wires can be disposed to be aligned within the slots so as to minimize the gaps defined therein, and this increases the space factor, thereby making it possible to increase the motor efficiency.

Coil end portions 17, 117 of the coils of the plurality of phases may be disposed alternately on the stator core in accordance with the order of turns of the plurality of phases.

According to this method, the coil volume is reduced, and the coil resistance and copper loss are suppressed, whereby the motor efficiency can be increased. In addition, a reduction in weight and size of the motor can be realized.

Each of the insulation members may be an elastic resin member 12, 112.

According to this method, in forming coils of a plurality of phases, even in the event that the wires are distributed-wound in the insulation members while being tensioned, there is caused no fear that the wires are damaged, whereby the predetermined motor performance is maintained.

A tension applied to each of the wires may be equal to or smaller than an allowable elastic stress of the wire and/or equal to or smaller than an allowable compression strength of the insulation member.

According to this method, in forming coils of a plurality of phases, even in the event that the wires are distributed-wound in the insulation members while being tensioned, there is caused no such situation that the wires and the insulation members are plastically deformed, whereby the predetermined motor performance is maintained.

An opening portion 18, 118 of the slot may be opened in an inside diameter surface 19, 119 of the stator core.

According to this method, the motor stator can preferably be used as a motor stator for an inner rotor type motor.

The coils may comprise coils of three phases of a U-phase, a V-phase and a W-phase. The coils of the three phases may be formed by wave-winding the wires in the plurality of slots so that coil end portions of the coils of the two phases are aligned in a radial direction.

According to this method, the coil volume can be reduced, and this suppresses the coil resistance and copper loss, whereby the motor efficiency can be increased. In addition, a reduction in weight and size of the motor can be realized.

### DESCRIPTION OF REFERENCE NUMERALS AND SIGNS

10 motor stator
11 stator core
12 insulation member (resin member)
13 coil
13u U-phase coil
13v V-phase coil
13w W-phase coil
16 slot
17 coil end portion
18 opening portion
19 inner circumferential surface of stator core
20, 20A wire (single wire)
21 distal end of wire
23 joined portion
40 conductor wire
41 insulating surface coating
41A composite insulating surface coating
42 inorganic particle
43 resin
T circumferential space in insulation member.
110 motor stator
111 stator core
112 insulation member (resin member)
113 coil
113u U-phase coil
113v V-phase coil
113w W-phase coil
116 slot
116u U-phase slot
116v V-phase slot
116w W-phase slot
117 coil end portion
117u U-phase coil end portion
117v V-phase coil end portion
117w W-phase coil end portion
118 opening portion
119 inner circumferential surface of stator core
120 wire
S space factor.

What is claimed is:

1. A motor stator comprising:
a stator core having a plurality of slots;
insulation members which are disposed in the plurality of slots; and
coils of a plurality of phases which are respectively formed by distributed-winding wires in prescribed slots of said plurality of slots disposed spaced apart at intervals of a predetermined number of slots via the insulation members,
wherein the wires are disposed within the insulation members in a condition that tensions are applied to the wires, and
the stator core, the insulation members and the coils are physically fixed together by the tensions of the wires.

2. The motor stator according to claim 1, wherein each of the wires is made up of a plurality of strands.

3. The motor stator according to claim 1, wherein each of the wires is made of a single wire.

4. The motor stator according to claim 3, wherein the single wire is coated with an insulating surface coating of 110 μm or larger.

5. The motor stator according to claim 3, wherein the single wire is coated with a composite insulating surface coating in which inorganic particles are dispersed in a resin.

6. The motor stator according to claim 3, wherein the single wire is coated with an inorganic insulating surface coating.

7. The motor stator according to claim 3, wherein the single wire comprises a conductor wire having a substantially rectangular section and an insulating surface coating which covers an outer surface of the conductor wire.

8. The motor stator according to claim 7, wherein the conductor wire has a sectional area which is constant and a sectional shape which differs in accordance with the order of turns.

9. The motor stator according to claim 3, wherein the coils are each formed by inserting a plurality of wires each formed into a substantially U-shape into the slots and joining together distal ends of the wires.

10. The motor stator according to claim 1, wherein coil end portions of the coils of the plurality of phases are disposed alternately on the stator core in accordance with the order of turns of the coils of the plurality of phases.

11. The motor stator according to claim 1, wherein the insulation member is an elastic resin member.

12. The motor stator according to claim 1, wherein a tension applied to each of the wire is equal to or smaller than an allowable elastic stress of the wire and/or equal to or smaller than an allowable compression strength of the insulation member.

13. The motor stator according to claim 1, wherein an opening portion of each of the slots is opened in an inner circumferential surface of the stator core.

14. The motor stator according to claim 1, wherein a space factor of the coil disposed within the slot is equal to or larger than 40%.

15. The motor stator according to claim 1, wherein the coils of the plurality of phases comprise coils of three phases including U-phase, V-phase and W-phase, and
wherein the coils of the three phases are formed by wave-winding the wires in the slots so that coil end portions of the coils of the two phases are aligned in a radial direction.

16. A manufacturing method of a motor stator in which coils of a plurality of phases are formed by distributed-winding wires in a plurality of slots which are provided on a stator core and disposed spaced apart with a predetermined number of slots interposed therebetween, the method comprising:
disposing insulation members in the plurality of slots for establishing electrical insulation between the stator core and the wires;
distributed-winding the wires in the plurality of slots; and
disposing the wires within the insulation members in a condition that tensions are applied to the wires, and physically fixing the stator core, the insulation members and the coils together.

17. The manufacturing method according to claim 16, wherein each of the wires is made up of a plurality of strands.

18. The manufacturing method according to claim 17, wherein the step of distributed-winding comprises:
inserting the wires into a corresponding insulation member of a first slot from an axial end side towards the other axial end side of the stator core;
holding the wires which are pulled out of the first slot in a position lying radially outwards of the first slot on the other axial end side of the stator core with a tension applied to the wires;
rotating the stator core together with the wires by a predetermined angle so that the wires are located at a second slot into which the wires are to be inserted next;
holding the wires in a position lying radially outwards of the second slot on the other axial end side of the stator core;
inserting the wires in a corresponding insulation member in the second slot from the other axial end side to the axial end side of the stator core;
holding the wires which are pulled out of the second slot in a position lying radially outwards of the second slot on the axial end side of the stator core with a tension applied to the wires;
rotating the stator core together with the wires by a predetermined angle so that the wires are located at a third slot into which the wires are to be inserted next; and
holding the wires in a position lying radially outwards of the third slot on the axial end side of the stator core, and
wherein the series of steps in the distributed-winding step are repeatedly executed.

19. The manufacturing method according to claim 16, wherein each of the wires is made of a single wire.

20. The manufacturing method according to claim 19, wherein the step of distributed-winding comprises:
inserting the wires which are each formed into a substantially U-shape in advance in the slots;
bending distal ends of the wires inserted in the slots in a circumferential direction of the stator core, and applying the tensions to the wires; and
joining together the distal ends of the wires of the same phase.

21. The manufacturing method according to claim 19, wherein the single wire is coated with a composite insulating surface coating in which inorganic particles are disposed in a resin.

22. The manufacturing method according to claim 19, wherein the single wire is coated with an inorganic insulating surface coating.

23. The manufacturing method according to claim 19, wherein the wires are each a flat angular single wire having a sectional shape which differs every turn and a sectional area which is constant.

24. The manufacturing method according to claim 16, wherein coil end portions of the coils of the plurality of phases are disposed alternately on the stator core in accordance with the order of turns of the plurality of phases.

25. The manufacturing method according to claim 16, wherein each of the insulation members is an elastic resin member.

26. The manufacturing method according to claim 16, wherein a tension applied to each of the wires is equal to or smaller than an allowable elastic stress of the wire and/or equal to or smaller than an allowable compression strength of the insulation member.

27. The manufacturing method according to claim 16, wherein an opening portion of the slot is opened in an inside diameter surface of the stator core.

28. The manufacturing method according to claim 16, wherein the coils comprise coils of three phases of a U-phase, a V-phase and a W-phase, and
wherein the coils of the three phases are formed by wave-winding the wires in the plurality of slots so that coil end portions of the coils of the two phases are aligned in a radial direction.
